(19) United States
(12) Patent Application Publication
(10) Pub. No.: US 2026/0066555 A1
(43) Pub. Date: Mar. 5, 2026

(54) DETACHABLE TERMINAL BLOCK FOR AUDIO EXPANDER CONTROL NETWORK

(71) Applicant: Speaker Snap LLC, Fishers, IN (US)

(72) Inventor: Richard H. Goren, Fishers, IN (US)

(73) Assignee: Speaker Snap LLC, Fishers, IN (US)

(21) Appl. No.: 18/654,372

(22) Filed: May 3, 2024

(51) Int. Cl. H01R 9/24; H01R 4/48

(52) U.S. Cl. CPC H01R 9/2408; H01R 4/4816; H01R 4/483; H01R 4/4835; H01R 9/2416; H01R 9/2491

(57) ABSTRACT

A detachable terminal block configured to toollessly connect to a wire and an outlet. The terminal block includes a spring and a busbar. The spring is configured to selectively couple the busbar to the wire. The terminal block further includes a lever that is operable to compress and relax the spring. The busbar includes a socket that is configured to receive a pin in the outlet. The terminal block includes couplers that are configured to connect multiple terminal blocks together. In one example, the couplers include pegs and holes. The holes are configured to receive the pegs and couple multiple terminal blocks together using a friction fit. The terminal block is formed from two pieces that are configured to couple together. In one example, the pieces couple together using pegs and holes and/or a snap-fit connection.

### BACKGROUND

Terminal blocks can be used to electrically connect various electrical conductors and components. For example, a user can use a terminal block to couple multiple cables and/or devices to carry an audio signal, transfer power, transmit data, and/or for other purposes. With some terminals, the electrical and mechanical coupling between wires and/or other types of conductors is incomplete and/or unreliable. Such connections can cause interruptions in electrical signals, inconsistent power transfer, sparks between electrical conductors, and/or increases in electrical impedance among other effects.

Thus, there is a need for improvement in this field.

### SUMMARY

Terminal blocks are often used to connect audio/visual (AV) systems. Sometimes pluggable style terminal blocks, such as Phoenix connectors or Euroblocks, are specifically used to connect speaker wires to sound systems, such as audio amplifiers, or other electronic devices. Many Euroblocks and other terminal blocks require a user to unscrew a housing, insert the wire, tighten a set screw to secure the wire, and then screw back on the housing. As should be appreciated, the process is time-consuming and difficult. In some instances, the process does not ensure that the wire is fully secured which can allow the wire to disconnect from the terminal block among other complications. This can be a significant issue when setting up and breaking down sound equipment at concerts and in studios.

A unique pluggable terminal block has been developed to enable quick and secure electrical connections. In one example, the terminal block is generally in a form similar to a Euroblock or Phoenix connector. In one specific example, the terminal block is in a form of a Combicon type Phoenix connector. In another example, the terminal block is configured to connect to wires crimped using a Crimpfox device. The terminal block generally includes a shell and a cover. In one example, the shell and cover are formed through injection molding and/or another manufacturing process. The shell and cover are generally shaped to facilitate removing the shell and cover from molds. For example, the shell and cover are configured to quickly release from molds in a single motion. Further, the shell and cover are configured to support quick and reliable assembly of the terminal block during manufacturing. The shell defines a cavity to receive internal components of the terminal block. For example, the cavity is configured to receive a busbar and a spring. The shell is shaped to allow the busbar and spring to enter the cavity from one direction in a single motion. The cover is configured to couple to the shell in a single motion, for example by pressing the shell and cover together. In one example, the terminal block is assembled by depositing the busbar and spring into the cavity of the shell and then by pressing the cover onto the shell. In another example, the shell, cover, busbar, and spring are assembled to form the terminal block simultaneously.

Instead of having a screw to clamp the wires, the terminal block includes a lever mechanism that is able to quickly secure to and disengage from the wires. The terminal block includes a body configured to retain and secure a wire. The terminal block further includes a plug configured to couple to a port, outlet, and/or socket. The plug is configured to retain an electrical pin in the port. The terminal block generally includes a connector system configured to couple one or more terminal blocks together. In one example, the terminal block supports an electrical connection along one path. Using single-path terminal blocks allows a user to assemble multiple terminal blocks to connect an exact number of conductors to the port and/or outlet.

The terminal block includes a lever configured to actuate an internal spring. The lever is rotatable between an open and closed position. The lever is generally bistable in both the open position and the closed position. The lever is generally configured to move the spring between an open position configured to receive a wire and a closed position configured to retain the wire. The lever includes a tail that is angled to the rest of the lever. As the lever rotates, the tail is configured to compress the spring. The lever further defines a cam surface that is configured to contact the spring. The cam surface is smooth and follows a consistent curve. Using a smooth and consistent cam surface, the lever is configured to compress and release the spring in a smooth and controlled way. In one example, the spring includes an aperture configured to receive the wire when the lever is in the open position. The aperture is further configured to surround and retain the wire when the lever is in the second position.

The spring aperture is sized to receive wires ranging in size from 12-24 American wire gauge (AWG). In another example, the lever is perpendicular to the body of the terminal block in the open position and is parallel to the body of the terminal block in the closed position. In the open position, the lever applies a compression force to the spring. Generally, the compression force moves the spring aperture vertically (e.g. downward). Thus, the spring aperture is exposed and able to receive the wire. When the lever rotates, the lever is configured to apply force to an arm of the spring. The arm is configured to flex around a fulcrum of the spring relative to the busbar. The arm is relatively short compared to the busbar. By using a relatively short arm, the lever must apply a substantial force to compress the spring. The substantial force threshold ensures that the spring retains the wire securely and that the spring does not inadvertently release the wire. In the closed position, the lever is not in contact with the spring. The spring is generally loop-shaped. In one example, the spring is made from aluminum. In another example, the spring is made from stainless steel, but it should be appreciated that the spring can be made from other electrically conductive materials.

The pluggable terminal block further includes a busbar configured to transfer electricity between conductors at either end of the terminal block. For example, the wire transfers electricity into the terminal block, along the busbar, and into a device. In one example, the busbar is made from a highly conductive material, such as copper, aluminum, silver, and/or gold. In another example, the busbar is plated with a conductive material (e.g., gold plated). In one embodiment, the busbar extends through the aperture of the spring. For example, the busbar and spring include guides that are configured to extend through the aperture. The guides on the busbar and spring are angled at multiple points. For example, the guides on the busbar and spring form a zigzag shape. The shape of the guides is configured to help secure the busbar and spring together. Further, the shape of the guides is generally angled toward the wire when the wire is in the aperture. In one variation, the shape of the guides support the busbar to contact the wire across a large surface area. For example, the busbar and the spring aperture are configured to form a sandwich arrangement with the wire. As should be appreciated, this arrangement clamps the wire between the spring and the busbar in a secure connection.

Within the plug, the busbar includes a socket that is configured to receive pins from the port. The busbar is generally straight leading to the socket. The structure of the busbar supports the busbar to resist deforming as the pin pushes into the socket. The socket includes two leaves that extend toward the port and define a pin opening. A bridge spaces the leaves apart from one another, such as in a vertical direction. The bridge is generally c-shaped and is configured to fit around a portion of the terminal block. The leaves extend at an angle towards each other. The leaves then transition into curved arches. The arches are positioned closely across from each other and/or contact one another. By extending toward each other, the leaves allow the arches to contact and electrically connect to the pin. When the pin is inserted into the pin opening of the socket, the socket is configured to automatically contact and secure the pin in position. The arches further apply a compressive force to the pin to limit movement of the pin and to maintain the electrical connection. The arches then transition into lips that curve outward and define a mouth. By curving outward, the lips and arches allow a pin to separate the arches and move into the pin opening between the leaves. The plug portion further includes a fin that is configured to align and mechanically secure the terminal block within a receptacle on the port. As should be appreciated, the socket allows a user to establish a secure electrical connection by simply pushing the terminal block into the port.

The shell and cover are configured to couple together using a variety of types of joints and/or connections. In one variation, the shell and cover are configured to couple together using a snap-fit joint. In another variation, the shell and cover are configured to couple together using a tongue and groove joint. In yet another embodiment, the shell and cover are configured to couple together using one or more pegs and holes. The holes on the shell are configured to receive the pegs on the cover. The pegs and holes are configured to couple together using a friction fit. In one example, the shell and cover include pegs and holes with varying sizes. For instance, the cover includes a dowel that is larger than the other pegs. In one variation, the dowel is positioned near a pivot of the lever so as to reinforce coupling between the shell and cover near the lever. The pegs and holes are generally arranged such that the shell and cover are only able to couple together in one orientation.

The terminal block includes multiple support structures for the spring and busbar. In one variation, the terminal block includes a bracket. The spring is configured to wrap around the bracket. The bracket is configured to support the spring, particularly as the spring flexes about the fulcrum. The bracket is further configured to secure the spring and busbar against a base support. Further, the terminal block includes stoppers for the spring and lever. One stopper is configured to support the lever in the closed position and to limit movement of the lever in the open position. One stopper is configured to secure the spring in place and/or limit the range the spring is able to flex. The terminal block additionally includes a ridge to support the bridge of the busbar socket. In one variation, the terminal block defines multiple holes through one or more support structures. For example, the central support defines one or more holes which cause the bracket to have a partially round shape. Further, the support structures provide structural support for the shell and cover.

The connector system on the terminal block is configured to connect two or more terminal blocks together. Generally, the connector system is positioned on two sides of the terminal block to couple to multiple terminal blocks on each side. In one example, the connector system includes pegs and/or holes. The holes are configured to retain the pegs, such as through a friction fit. In one variation, the holes extend fully through the shell, and the pegs extend on each side of the cover. In another variation, only some holes extend fully through the shell. For example, the shell retains greater structural stability by only extending some holes fully through the shell rather than all holes. The pegs are configured to couple to the shell in the same terminal block on one side and to couple to another terminal block on an opposite side. The holes are configured to receive pegs from the cover in the same terminal block on one side and to receive pegs from another terminal block on an opposite side. The hole and peg arrangement allows the terminal block to be manufactured reliably and quickly. In one variation, extending the holes fully through the shell allows the shell to be reliably formed and released from an injection mold. In another variation, extending the pegs on either side of the cover allows the cover to be reliably formed and released from an injection mold. The pegs and holes are generally arranged such that the terminal blocks are only able to couple in one orientation. In the terminal block assembly, the multiple terminals generally form a consistent body portion. Conversely, the plugs of the multiple terminal blocks are configured to be separated by gaps in the terminal block assembly. As should be appreciated, the terminal block assembly is configured to be assembled using any number of terminal blocks that a user desires.

In an example use case, a user begins by rotating the lever into the open position. As mentioned above, the lever applies force to the spring in the open position, thus exposing the spring aperture. The user then inserts the wire into the spring aperture via a wire opening in the body. Once the wire is within the spring aperture, the user rotates the lever into the closed position. As mentioned above, the lever does not apply force to the spring in the closed position, thus the spring aperture moves vertically upward, sandwiching the wire between the spring aperture and the busbar. As should be appreciated, the wire and busbar are electrically connected once the wire is in contact with the busbar. To remove the terminal block from the wire, the user rotates the lever into the open position and pulls the wire out of the spring aperture.

In another example case, the user can insert the plug into the port. As the user inserts the plug, the pin of the port contacts the socket of the busbar. The arches of the socket compress the pin to maintain contact and electrical connection between the pin and busbar. To remove the terminal block from the port, the user pulls the terminal block out of the port. In one instance, the terminal block includes a recess and/or notch that provides space for the user to grab the terminal block. The user can connect the wire to the terminal block before, during, or after connecting the terminal block to the port.

The systems and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a terminal block assembly.

Aspect 3 generally concerns the system of any previous aspect including a terminal block.

Aspect 4 generally concerns the system of any previous aspect in which the terminal block is configured to clamp to a wire.

Aspect 5 generally concerns the system of any previous aspect including a port configured to receive the terminal block in a pluggable manner.

Aspect 6 generally concerns the system of any previous aspect in which the terminal block is a pluggable type terminal block.

Aspect 7 generally concerns the system of any previous aspect in which the terminal block is configured to couple to a second terminal block.

Aspect 8 generally concerns the system of any previous aspect in which the terminal block includes one or more pegs.

Aspect 9 generally concerns the system of any previous aspect in which the terminal block defines one or more holes.

Aspect 10 generally concerns the system of any previous aspect in which the terminal block includes a connector system.

Aspect 11 generally concerns the system of any previous aspect in which the connector system is configured to couple the terminal block to a second terminal block.

Aspect 12 generally concerns the system of any previous aspect in which the connector system includes one or more pegs and holes.

Aspect 13 generally concerns the system of any previous aspect including pegs and the holes are coupled via a friction fit.

Aspect 14 generally concerns the system of any previous aspect in which the terminal block includes a plug.

Aspect 15 generally concerns the system of any previous aspect in which the plug is configured to plug into a port.

Aspect 16 generally concerns the system of any previous aspect in which the plug includes a fin.

Aspect 17 generally concerns the system of any previous aspect in which the terminal block includes a shell and a cover.

Aspect 18 generally concerns the system of any previous aspect in which the shell is coupled to the cover.

Aspect 19 generally concerns the system of any previous aspect in which the shell and the cover are coupled together via one or more pegs and one or more holes.

Aspect 20 generally concerns the system of any previous aspect in which the cover is snap-fitted to the shell.

Aspect 21 generally concerns the system of any previous aspect including a busbar.

Aspect 22 generally concerns the system of any previous aspect including a spring.

Aspect 23 generally concerns the system of any previous aspect in which the spring is configured to couple a wire to the busbar.

Aspect 24 generally concerns the system of any previous aspect in which the spring has a loop shape.

Aspect 25 generally concerns the system of any previous aspect in which the spring is configured to flex between a first position and a second position.

Aspect 26 generally concerns the system of any previous aspect in which the spring defines an aperture.

Aspect 27 generally concerns the system of any previous aspect in which the aperture is configured to surround and retain the wire in the second position.

Aspect 28 generally concerns the system of any previous aspect in which the spring includes a guide positioned through the aperture.

Aspect 29 generally concerns the system of any previous aspect in which the spring has an arm with a leg that extends past the busbar and a fulcrum connecting the base to the arm.

Aspect 30 generally concerns the system of any previous aspect including a lever.

Aspect 31 generally concerns the system of any previous aspect in which the lever is configured to pivot between a closed position and an open position.

Aspect 32 generally concerns the system of any previous aspect in which the lever is bistable in the closed position and the open position.

Aspect 33 generally concerns the system of any previous aspect in which the lever is configured to pivot to actuate the spring.

Aspect 34 generally concerns the system of any previous aspect in which the lever is operable to selectively couple the terminal block to a wire.

Aspect 35 generally concerns the system of any previous aspect in which the terminal block is configured to receive a wire when the lever is in the open position.

Aspect 36 generally concerns the system of any previous aspect in which the terminal block is configured to couple to the wire when the lever is in the closed position.

Aspect 37 generally concerns the system of any previous aspect in which the lever is configured to apply a compressive force to the spring in the open position.

Aspect 38 generally concerns the system of any previous aspect in which the lever is configured to release the compressive force on the spring in the closed position.

Aspect 39 generally concerns the system of any previous aspect in which the spring includes an edge at the aperture.

Aspect 40 generally concerns the system of any previous aspect in which the edge and the busbar define a gap.

Aspect 41 generally concerns the system of any previous aspect in which the edge is configured to press the wire against the busbar to electrically connect the wire and the busbar.

Aspect 42 generally concerns the system of any previous aspect in which the busbar includes a socket configured to receive a pin.

Aspect 43 generally concerns the outlet configured to receive the terminal block in a pluggable manner of any previous aspect including a port including a pin.

Aspect 44 generally concerns the outlet configured to receive the terminal block in a pluggable manner of any previous aspect including a port defining a plug receptacle housing the pin.

Aspect 45 generally concerns the system of any previous aspect in which the socket includes at least two leaves.

Aspect 46 generally concerns the system of any previous aspect in which the leaves are oriented at a transverse angle to each other.

Aspect 47 generally concerns the system of any previous aspect in which the leaves curve to form arches.

Aspect 48 generally concerns the system of any previous aspect in which the arches curve away from each other to form lips.

Aspect 49 generally concerns the system of any previous aspect in which the arches are configured to compress a pin between each other.

Aspect 50 generally concerns the system of any previous aspect in which the lips define a mouth that is configured to receive the pin.

Aspect 51 generally concerns the system of any previous aspect in which the lips are configured to guide the pin into the socket.

Aspect 52 generally concerns the system of any previous aspect in which the socket is configured to secure the pin between the leaves.

Aspect 53 generally concerns the system of any previous aspect in which the socket includes a bridge that spans between the leaves.

Aspect 54 generally concerns the system of any previous aspect in which the bridge is c-shaped.

Aspect 55 generally concerns the system of any previous aspect in which the bridge extends around a portion of the terminal block.

Aspect 56 generally concerns the system of any previous aspect in which the bridge is configured to space at least one of the leaves from the others.

Aspect 57 generally concerns the system of any previous aspect in which the terminal block defines a cavity.

Aspect 58 generally concerns the system of any previous aspect in which the cavity is configured to receive the spring and busbar.

Aspect 59 generally concerns the system of any previous aspect in which the cavity is shaped to receive the spring and busbar in a single motion.

Aspect 60 generally concerns the system of any previous aspect in which the shell defines the cavity.

Aspect 61 generally concerns the system of any previous aspect in which the cover covers the cavity.

Aspect 62 generally concerns the system of any previous aspect in which the shell defines one or more holes that extend fully through the shell.

Aspect 63 generally concerns the system of any previous aspect in which the cover includes one or more pegs that extend from both sides of the cover.

Aspect 64 generally concerns the system of any previous aspect in which the holes are configured to receive the pegs from the cover on one side and pegs from another terminal block on an opposite side.

Aspect 65 generally concerns the system of any previous aspect in which the pegs are configured to couple to holes on the shell on one side and to holes on another terminal block on an opposite side.

Aspect 66 generally concerns the system of any previous aspect in which the terminal block includes a bracket.

Aspect 67 generally concerns the system of any previous aspect in which the bracket supports the spring.

Aspect 68 generally concerns the system of any previous aspect in which the spring wraps around a portion of the bracket.

Aspect 69 generally concerns the system of any previous aspect in which the bracket is at least in part round.

Aspect 70 generally concerns the system of any previous aspect in which the fulcrum of the spring is positioned around the bracket.

Aspect 71 generally concerns the system of any previous aspect in which the terminal block includes a stopper.

Aspect 72 generally concerns the system of any previous aspect in which the stopper is configured to limit the range of movement of the lever.

Aspect 73 generally concerns the system of any previous aspect in which the lever includes a tail.

Aspect 74 generally concerns the system of any previous aspect in which the terminal block includes a brace.

Aspect 75 generally concerns the system of any previous aspect in which the tail is configured to rest against the stopper in the closed position.

Aspect 76 generally concerns the system of any previous aspect in which the busbar is formed by cutting and bending a single piece of material.

Aspect 77 generally concerns the system of any previous aspect in which the terminal block includes a ledge configured to support the socket.

Aspect 78 generally concerns the system of any previous aspect in which the bridge is configured to extend around the ledge.

Aspect 79 generally concerns the system of any previous aspect in which the terminal block includes one or more supports for the spring and busbar.

Aspect 80 generally concerns the system of any previous aspect in which the terminal block assembly includes multiple plug portions.

Aspect 81 generally concerns the system of any previous aspect in which the terminal block assembly includes a first terminal block and a second terminal block.

Aspect 82 generally concerns the system of any previous aspect in which the first terminal block includes a first plug and the second terminal block includes a second plug.

Aspect 83 generally concerns the system of any previous aspect in which the first plug and the second plug define a gap between each other.

Aspect 84 generally concerns the system of any previous aspect in which the terminal block assembly forms a continuous body.

Aspect 85 generally concerns the system of any previous aspect in which the first terminal block is configured to sit flush against the second terminal block.

Aspect 86 generally concerns the system of any previous aspect in which the terminal block defines a recess configured to facilitate unplugging the terminal block.

Aspect 87 generally concerns the system of any previous aspect in which the terminal block defines a notch configured to facilitate unplugging the terminal block.

Aspect 88 generally concerns the system of any previous aspect in which the snap-fit connection is positioned on a plug of the terminal block.

Aspect 89 generally concerns the system of any previous aspect in which the cover has a flange.

Aspect 90 generally concerns the system of any previous aspect in which the shell includes a clasp.

Aspect 91 generally concerns the system of any previous aspect in which the shell defines a slot.

Aspect 92 generally concerns the system of any previous aspect in which the clasp is configured to secure the flange within the slot.

Aspect 93 generally concerns the system of any previous aspect in which the terminal block is configured to toollessly connect to a wire.

Aspect 94 generally concerns the system of any previous aspect in which the terminal block is configured to support one conduction path between one wire and one pin.

Aspect 95 generally concerns the system of any previous aspect including a second terminal block.

Aspect 96 generally concerns the system of any previous aspect including a second terminal block including one or more connectors.

Aspect 97 generally concerns the system of any previous aspect in which the connector system includes one or more pegs and one or more holes.

Aspect 98 generally concerns the system of any previous aspect including a spring having a base resting against the busbar.

Aspect 99 generally concerns the system of any previous aspect in which the brace is configured to contact the tail when the lever is in the open position.

Aspect 100 generally concerns the system of any previous aspect in which the lever is configured to rest on the brace in the closed position.

Aspect 101 generally concerns the system of any previous aspect in which the busbar is generally straight.

Aspect 102 generally concerns the system of any previous aspect in which the busbar includes a strut positioned near the spring.

Aspect 103 generally concerns the system of any previous aspect in which the busbar includes a transitional portion between the strut and socket.

Aspect 104 generally concerns the system of any previous aspect in which the transitional portion is not angled more than 45 degrees away from the strut or from the socket.

Aspect 105 generally concerns the system of any previous aspect in which the lever has a cam surface configured to contact the spring as the lever rotates.

Aspect 106 generally concerns the system of any previous aspect in which the second terminal block is connected to the terminal block via the connector system.

Aspect 107 generally concerns the system of any previous aspect in which the holes extend fully through the shell.

Aspect 108 generally concerns the system of any previous aspect in which the pegs extend from both sides of the cover.

Aspect 109 generally concerns the system of any previous aspect in which the shell and the cover are coupled together via the pegs and the holes.

Aspect 110 generally concerns the system of any previous aspect in which the pegs are coupled to the holes.

Aspect 111 generally concerns the system of any previous aspect in which the terminal block and the second terminal block each have a shell that defines one or more holes.

Aspect 112 generally concerns the system of any previous aspect in which the terminal block has a cover.

Aspect 113 generally concerns the system of any previous aspect in which the cover has one or more pegs extending from opposite sides of the cover.

Aspect 114 generally concerns the system of any previous aspect in which the pegs of the cover on one side of the cover are received in the shell of the terminal block.

Aspect 115 generally concerns the system of any previous aspect in which the pegs on an opposite side of the cover are received in the shell of the second terminal block.

Aspect 116 generally concerns the system of any previous aspect in which the busbar forms one of the leaves.

Aspect 117 generally concerns the system of any previous aspect in which the aperture is configured to retain the wire in the second position.

Aspect 118 generally concerns the system of any previous aspect in which the terminal block is a first terminal block.

Aspect 119 generally concerns the system of any previous aspect in which the first terminal block is configured to couple to a second terminal block.

Aspect 120 generally concerns the system of any previous aspect in which the spring is configured to flex between the closed position and the open position.

Aspect 121 generally concerns the system of any previous aspect in which the spring defines an aperture to receive the wire in the open position.

Aspect 122 generally concerns the system of any previous aspect in which the aperture of the spring closes to retain the wire against the busbar when in the closed position.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a system.

FIG. 2 is a front perspective view of a terminal block from the FIG. 1 system.

FIG. 3 is a rear perspective view of the FIG. 2 terminal block.

FIG. 4 is a front view of the FIG. 2 terminal block.

FIG. 5 is a rear view of the FIG. 2 terminal block.

FIG. 6 is a side view of the FIG. 2 terminal block with a lever in an open position.

FIG. 7 is an interior view of the FIG. 2 terminal block.

FIG. 8 is a cross-sectional view of the FIG. 2 terminal block in a closed position as taken along line 8-8 in FIG. 4.

FIG. 9 is a cross-sectional view of the FIG. 2 terminal block in an open position.

FIG. 10 is a cross-sectional view of the FIG. 2 terminal block in an open position and a wire.

FIG. 11 is a cross-sectional view of the FIG. 2 terminal block in a closed position and a wire.

FIG. 12 is a perspective view of a spring from the FIG. 2 terminal block.

FIG. 13 is a perspective view of a busbar from the FIG. 2 terminal block.

FIG. 14 is a perspective view of the FIG. 12 spring and the FIG. 13 busbar.

FIG. 15 is a front perspective view of a shell from the FIG. 2 terminal block.

FIG. 16 is a rear perspective view of the FIG. 15 shell.

FIG. 17 is a front perspective view of a cover from the FIG. 2 terminal block.

FIG. 18 is a rear perspective view of the FIG. 17 cover.

FIG. 19 is a front perspective view of a terminal block assembly including the FIG. 2 terminal block.

FIG. 20 is a rear perspective view of the FIG. 19 terminal block assembly.

FIG. 21 is a cross-sectional view of the FIG. 19 terminal block assembly as taken along line 21-21 in FIG. 19.

FIG. 22 is a cross-sectional view of the FIG. 19 terminal block assembly as taken along line 22-22 in FIG. 19.

FIG. 23 is a perspective view of a port from the FIG. 1 system.

FIG. 24 is a front view of the FIG. 23 port.

FIG. 25 is a front view of the FIG. 23 port and the FIG. 19 terminal block assembly.

FIG. 26 is a cross-sectional view of the FIG. 25 port and terminal block assembly as taken along line 26-26 in FIG. 25.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

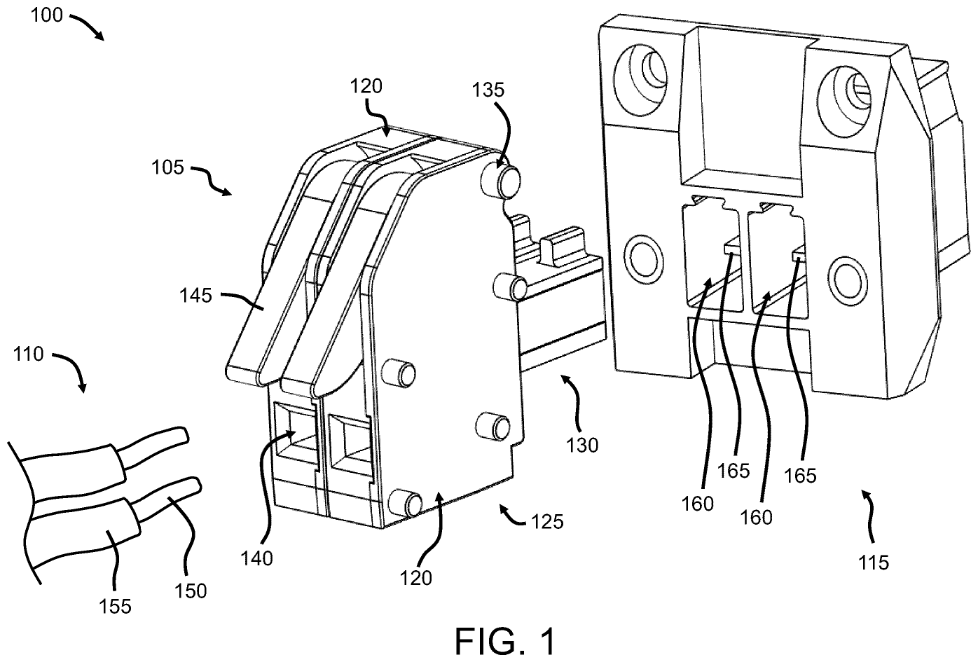

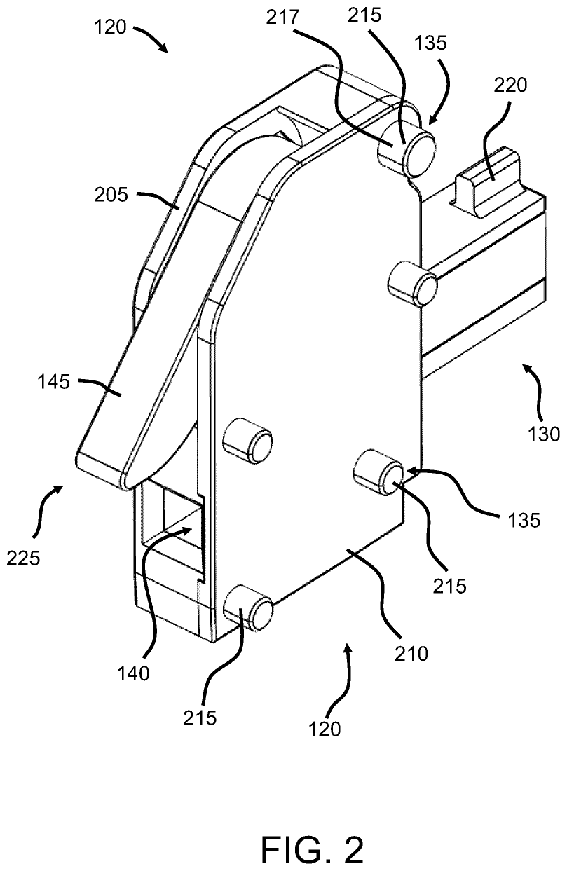

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 illustrates a system 100 according to one embodiment. The system 100 typically includes a terminal block assembly 105, a wire 110, and a port 115. The system 100 is generally configured to allow a user to make a toolless connection between the wire 110 and the port 115. For example, the system 100 is configured to connect speaker wire and/or another electrical conductor to a stereo, audio amplifier, speaker, and/or other device. As should be appreciated, the system 100 is configured to be used in a variety of applications to connect different devices and/or types of electrical conductors.

The terminal block assembly 105 is generally configured to electrically connect one or more wires 110 to the port 115. The terminal block assembly 105 is configured to electrically connect to and mechanically secure the wire 110 on one end. The terminal block assembly 105 is configured to connect to the wire 110 using a toolless connection. For example, the terminal block assembly 105 is configured to couple to the wire 110 without using solder, without using a screwdriver to tighten a screw against the wire 110, and/or without other external tools. On another end, the terminal block assembly 105 is configured to electrically connect to conductors in the port 115 and to mechanically secure to the port 115. The terminal block assembly 105 is configured to attach and detach from the port 115 to make such electrical and mechanical connections. In one example, the terminal block assembly 105 includes a Euroblock, Phoenix connector, and/or another pluggable style connector. In this way, the terminal block assembly 105 supports quick and secure toolless connections between the wire 110 and port 115. In one specific example, the terminal block is in a form of a Combicon type Phoenix connector. In another example, the terminal block is configured to connect to wires crimped using a Crimpfox device. Typically, the terminal block assembly 105 is configured to electrically connect each wire 110 to the port 115 along a separate conduction path. In the illustrated example, the terminal block assembly 105 supports electrical connections along two different conduction paths. In an alternate example, the terminal block assembly 105 is configured to receive more than two wires 110 and/or support electrical connections along more than two conduction paths.

As illustrated, the terminal block assembly 105 includes one or more terminal blocks 120. The terminal blocks 120 are configured to electrically and mechanically connect to the wires 110 and port 115. Each terminal block 120 is configured to electrically connect one wire 110 to the port 115 along one conduction path. By supporting one conduction path, the terminal block 120 enables a user to construct the terminal block assembly 105 configured to receive a custom number of wires 110. The terminal block 120 enables the user to form the terminal block assembly 105 to the exact size the user needs. In an alternate embodiment, one or more terminal blocks 120 are configured to receive more than one wire 110 and/or support electrical connections along more than one conduction path. The terminal block assembly 105 includes multiple of the same type of terminal block 120 and/or includes different types of terminal blocks 120. As should be appreciated, the terminal block assembly 105 is configured to be constructed from any number of terminal blocks 120 and/or using any variety of terminal blocks 120 that support different numbers of conduction paths.

The terminal block 120 generally includes a body 125 and a plug 130. The body 125 is generally larger than the plug 130. The body 125 typically extends out of the port 115 when the terminal block assembly 105 is attached to the port 115. The body 125 generally provides an area for a user to grab the terminal block 120 when connecting or disconnecting a wire 110 to the terminal block 120 and/or when attaching or detaching the terminal block 120 to the port 115. The plug 130 generally is positioned within the port 115 when the terminal block assembly 105 is attached to the port 115. The shape of the plug 130 is configured to secure the position of the terminal block 120 relative to the port 115. For example, the plug 130 is shaped to limit or fully prevent rotation, lateral movement, and/or other types of movement of the terminal block 120 within the port 115. In the illustrated example, the body 125 and plug 130 are portions of the same pieces of material in the terminal block 120. Alternatively, the body 125 and plug 130 are configured to each be formed as one or more separate pieces of material.

Each terminal block 120 includes a connector system 135. The connector system 135 is configured to mechanically couple one terminal block 120 to another terminal block 120. The connector system 135 is generally positioned on each lateral side of the terminal block 120. The connector system 135 allows the terminal block 120 to couple to at least one other terminal block 120 on each lateral side. The connector system 135 further allows a user to couple a customized amount of terminal blocks 120 in a series in this way. In the illustrated example, the connector system 135 couples the terminal blocks 120 through a mortise and tenon and/or a dowel joint. In another example, the connector system 135 is configured to couple the terminal blocks 120 through a dovetail, groove, and/or another type of joint. In yet another example, the connector system 135 includes clips, fasteners, magnets, buttons, and/or another type of device to couple the terminal blocks 120. As should be appreciated, the terminal block 120 is configured to include any number, type, and/or any combination of types of connector system 135.

The terminal block 120 defines a wire opening 140 that is configured to receive the wire 110. In the illustrated example, the wire opening 140 is generally square shaped. In another example, the wire opening 140 is round, polygonal, irregularly shaped, and/or a combination of different shapes. Further, the wire opening 140 is chamfered around an outer portion. The chamfered shape slopes towards a central point of the wire opening 140 from an outer portion to an inner portion of the terminal block 120. Using the chamfered shape, the wire opening 140 is configured to facilitate a user inserting the wire 110 into the wire opening 140. The wire opening 140 is configured to guide the wire 110 towards a central position within the wire opening 140 using the sloped edges. As should be appreciated, the wire opening 140 is configured to be shaped in any way sufficient to receive the wire 110 and/or be shaped to receive a specific type of wire 110, such as a certain range of American Wire Gauge (AWG) sizes.

The terminal block 120 further includes a lever 145. The lever 145 is configured to move between two positions. Typically, the lever 145 is bistable. The lever 145 is configured to remain in either of the two positions after a user has changed the position of the lever 145. Operating the lever 145 allows the terminal block 120 to selectively couple to a wire 110. With the lever 145 in one position, the terminal block 120 is configured to freely receive or eject the wire 110. For example, a user can freely insert or remove the wire 110 from the wire opening 140. With the lever 145 in the other position, the terminal block 120 is configured to secure the wire 110 in place. Using a bistable lever 145 allows the user to set the position of the lever 145 once without having to hold the lever 145 in that position. The lever 145 facilitates connecting and disconnecting the wire 110 to the terminal block 120 by maintaining a desired position as the user inserts or removes the wire 110.

As illustrated, the wire 110 includes a conductive portion 150 and an insulated portion 155. The conductive portion 150 is made of an electrically conductive material, such as copper and/or aluminum. The conductive portion 150 is configured to carry an electrical signal, such as a digital audio signal, a power signal, and/or another type of signal. The conductive portion 150 is generally configured to electrically connect the terminal block 120 to another device, such as a stereo, speaker, and/or other device. Conversely, the insulated portion 155 is made of an electrically insulating material that does not conduct electrical current. The insulated portion 155 is configured to prevent incidental contact between the conductive portions 150 in multiple wires 110 and/or between the conductive portion 150 and an external electrical conductor. Further, the insulated portion 155 provides physical protection for the conductive portion 150, such as protection from dirt, water, dust, and/or other substances. In the illustrated example, the wire 110 is a solid wire construction that includes one internal conductive portion 150 and a surrounding insulated portion 155. In another example, the wire 110 includes a stranded wire construction that includes multiple strands of conductive portion 150 that are separated and surrounded by the insulated portion 155. The size of the conductive portion 150 is typically based on standard AWG sizes. For instance, the conductive portion 150 is between 12 AWG and 24 AWG. As should be appreciated, the terminal block 120 is configured to receive the wire 110 in any size and/or any construction. Further, the terminal block 120 is configured to receive the wire 110 in a variety of forms, such as an electrical pin and/or another type of electrical conductor.

The port 115 generally includes a plug opening 160 and a pin 165. The plug opening 160 is configured to receive the terminal block 120. Specifically, the plug opening 160 is shaped to receive the plug 130. In one example, the plug opening 160 is shaped so as to limit or prevent rotation, lateral movement, and/or other movement of the terminal block 120 when coupled to the terminal block 120. The pin 165 is made of an electrically conductive material, such as copper or aluminum. In one example, the pin 165 is gold-plated and/or platinum-plated. The pin 165 is configured to electrically connect the terminal block 120 to a stereo, speaker, and/or other device. For example, the port 115 is part of such a device and supports electrical connections through the pin 165. In another example, the port 115 is installed on a wall and/or another structure and indirectly connects to such a device through wires and/or another conductor. In the illustrated example, the port 115 defines one plug opening 160 for each pin 165. Each plug opening 160 is configured to receive the plug 130 from one terminal block 120. Positioning one terminal block 120 in each plug opening 160 provides stability for connecting a single terminal block 120. As should be appreciated, the plug openings 160 on the port 115 are configured to be arranged in any way sufficient to receive the terminal block assembly 105, such as one or more large plug openings 160 that accommodate more than one terminal block 120.

Referring to FIG. 2, a perspective view of one terminal block 120 is illustrated. The terminal block 120 includes a shell 205 and a cover 210. The shell 205 and cover 210 form the structure of the terminal block 120. The shell 205 and cover 210 are typically made from a rigid material, such as plastic. In one example, the shell 205 and/or cover 210 are formed each as a single piece of material using injection molding. The shell 205 and cover 210 are generally shaped to facilitate removing the shell 205 and cover 210 from molds. For example, the shell 205 and cover 210 are configured to quickly release from molds in a single motion. Alternatively, the shell 205 and/or cover 210 are configured to be formed using compression molding, 3D printing, and/or another technique. Further, the shell 205 and cover 210 are typically made from an electrically insulative material.

As illustrated, the shell 205 forms one lateral portion of the terminal block 120 and the cover 210 forms the other lateral portion of the terminal block 120. In one example, the shell 205 and cover 210 are coupled through a friction fit. In another example, the shell 205 and cover 210 are coupled through a snap-fit joint, a tongue and groove joint, and/or another type of joint. The shell 205 and cover 210 are configured to be coupled together without using any additional fasteners. For example, to simplify manufacturing, the shell 205 and cover 210 are assembled by pressing the shell 205 and cover 210 together with sufficient force. The shell 205 and cover 210 allow the terminal block 120 to be formed quickly and reliably in a single motion. The two-piece construction makes manufacturing the terminal block 120 more cost-effective, reliable, and/or quicker than a construction that requires additional fasteners.

In one embodiment, the connector system 135 includes one or more pegs 215. The pegs 215 are positioned on the cover 210. The pegs 215 are generally configured to couple one terminal block 120 to another terminal block 120, for example using a friction fit. The pegs 215 are integrally formed with the cover 210. Integrally forming the pegs 215 with the cover 210 reinforces the strength of the cover 210 and the terminal block 120 as a whole. Further, integrally forming the pegs 215 with the cover 210 facilitates fast, cost-effective, and/or reliable manufacturing of the cover 210. The pegs 215 are arranged such that two terminal blocks 120 are only able to couple together in one orientation. In this way, the connector system 135 ensures that the terminal blocks 120 are properly aligned in the terminal block assembly 105. Alternatively, the pegs 215 are configured to be arranged in a variety of positions and/or in any amount. In one example, the pegs 215 are evenly distributed across the cover 210. In another example, the pegs 215 are positioned strategically to facilitate coupling and decoupling multiple terminal blocks 120. For instance, the pegs 215 can be positioned near the front and rear ends of the cover 210 to allow a user to apply a more direct force when coupling and/or decoupling the terminal blocks 120. Further, the cover 210 can include multiple pegs 215 with varying size. As should be appreciated, the pegs 215 could be positioned on and/or part of the shell 205 in addition to or instead of on the cover 210.

The pegs 215 in one variation include one or more dowels 217. In the illustrated example, the cover 210 includes one dowel 217. The dowel 217 is generally larger than the other pegs 215. The larger size of the dowel 217 supports stronger coupling between the shell 205 and cover 210 at that location. For example, the dowel 217 resists deformation and/or inhibits movement between the shell 205 and cover 210 to a greater extent than the pegs 215. In one instance, the dowel 217 is positioned near the lever 145 to provide strong support for the terminal block 120 near the lever 145. Supporting coupling between the shell 205 and cover 210 near the lever 145 ensures reliable rotation of the lever 145.

The terminal block 120 further includes a fin 220 positioned on the plug 130. The fin 220 extends distally from a main section of the plug 130. In one example, the fin 220 is integrally formed with the shell 205. In an alternate example, the fin 220 is part of the cover 210 and/or a separate part. The fin 220 is configured to limit rotation and/or lateral movement of the terminal block 120 when coupled to the port 115. The shape of the fin 220 is configured to generally complement a portion of the plug opening 160, shown in FIG. 1. Further, the shape of the fin 220 is generally consistent along a length. The consistent shape of the fin 220 enables the plug 130 to slide into and out of the plug opening 160 on the port 115.

In FIG. 2, the lever 145 is in a closed position 225. When the lever 145 is in the peg 215, the terminal block 120 is configured to retain and couple to the wire 110 and/or prevent the wire 110 from entering. Typically, the lever 145 is stable in the closed position 225 so as to maintain the same position. In one example, the lever 145 is biased towards the closed position 225. For instance, the lever 145 is configured to automatically move to the closed position 225 after a user moves the lever 145 out of the closed position 225. In another example, the lever 145 is biased towards the closed position 225 up to a certain point of rotation. After being rotated beyond that point, the lever 145 becomes biased towards another position.

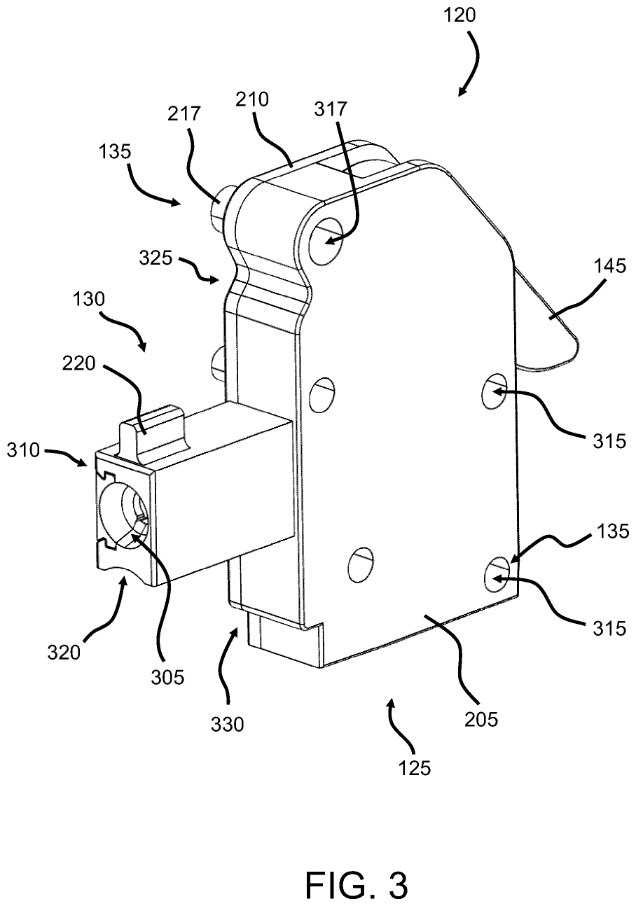

Referring to FIG. 3, the terminal block 120 defines a pin opening 305. The pin opening 305 is configured to receive the pin 165 of the port 115 shown in FIG. 1. As illustrated, the pin opening 305 is positioned on the plug 130. When the plug 130 is inserted into the plug opening 160, the pin 165 extends through the pin opening 305. In the illustrated example, the pin opening 305 is round. Alternatively, the pin opening 305 is configured to be shaped in another way that accommodates the pin 165. Further, the pin opening 305 is chamfered around an outer portion. The chamfered shape slopes towards a central point of the pin opening 305 from an outer portion to an inner portion of the terminal block 120. Using the chamfered shape, the pin opening 305 is configured to facilitate a user connecting the terminal block 120 and the port 115. For example, the sloped sides of the pin opening 305 are configured to guide the pin 165 into the pin opening 305. As should be appreciated, the pin opening 305 is configured to receive another type of conductor, such as a portion of a wire and/or busbar as examples.

As illustrated, the terminal block 120 includes a snap-fit connection 310. The snap-fit connection 310 is configured to couple the shell 205 and cover 210 together. In the illustrated example, the snap-fit connection 310 is positioned on the plug 130. In an alternate example, the snap-fit connection 310 is positioned at one or more other locations between the shell 205 and cover 210. Although the terminal block 120 is made of a generally rigid material, the material is configured to flex to a limited degree. For example, the material is just flexible enough to enable the use of the snap-fit connection 310. The snap-fit connection 310 facilitates manufacturing the terminal block 120 using a single motion to couple the shell 205 and cover 210. The shell 205 and cover 210 need only to be pressed together to couple at the snap-fit connection 310. Further, the snap-fit connection 310 is configured to prevent or inhibit disassembly of the terminal block 120. In one example, the snap-fit connection 310 couples the shell 205 and cover 210 together stronger than another type of joint.

The terminal block 120 defines one or more holes 315. In the illustrated embodiment, the connector system 135 includes the holes 315 in addition to the pegs 215. Specifically, the terminal blocks 120 are configured to couple together using the holes 315 and the pegs 215. In one example, the holes 315 are positioned only on the shell 205. The holes 315 are configured to receive the pegs 215. The holes 315 are positioned and sized to correspond with the position and size of pegs 215. The position of the holes 315 and pegs 215 enables the terminal blocks 120 to couple only in one orientation. In one example, the holes 315 are shaped to exactly or nearly exactly complement the pegs 215. For instance, the space defined by the holes 315 may be the exact or nearly exact shape and/or volume as the shape and/or volume of the pegs 215. In another example, the holes 315 are sized slightly smaller than the pegs 215. When the hole 315 receives the peg 215, the hole 315 and/or peg 215 can slightly deform to allow the peg 215 to be positioned in the hole 315. By closely mirroring the shape of the hole 315 with the shape of the peg 215, the peg 215 and hole 315 are configured to support a reliable mechanical connection. In one example, the friction between the surfaces of the peg 215 and hole 315 is sufficient to secure two terminal blocks 120 together. In this way, the pegs 215 and holes 315 limit or fully prevent relative movement of the terminal blocks 120 when coupled together. Further, the pegs 215 and holes 315 support coupling between two terminal blocks 120 using a single motion. A user only has to press two terminal blocks 120 together. The pegs 215 and holes 315 facilitate quick, reliable, and easy coupling of multiple terminal blocks 120. In an alternate embodiment, one or more of the pegs 215 and/or holes 315 are positioned on the shell 205 and/or cover 210.

As illustrated, the holes 315 include a distinct dowel hole 317 configured to receive the dowel 217. The dowel 217 and dowel hole 317 are generally configured to couple the shell 205 and cover 210 together more securely than the other pegs 215 and holes 315. In one example, the dowel 217 and dowel hole 317 contact each other across a larger surface than the pegs 215 contact the holes 315. The larger surface area increases the frictional force between the dowel 217 and the dowel hole 317 relative to the peg 215 and hole 315. As should be appreciated, the shell 205 and cover 210 are configured to include one or more dowels 217 and dowel holes 317 in another position.

The terminal block 120 in one version defines a trough 320. The trough 320 is positioned on the plug 130. In one embodiment, the trough 320 is configured to accommodate a portion of the port 115. For example, the port 115 includes a rib and/or spline within the plug opening 160. When the terminal block 120 plugs into the port 115, such a rib and/or spline is positioned in the trough 320. The trough 320 has a consistent shape along a length to allow the plug 130 to slide into and out of the plug opening 160. When positioned in the plug opening 160, the trough 320 is configured to limit or prevent lateral movement and/or rotation of the terminal block 120. In this way, the trough 320 is configured to support stability of the terminal block 120 when coupling to the port 115.

The terminal block 120 in another variation further defines a recess 325 and a notch 330. The recess 325 and notch 330 are generally indentations and/or depressions in the terminal block 120. In the illustrated example, the terminal block 120 defines the recess 325 and notch 330 on the body 125. The recess 325 and/or notch 330 are configured to facilitate plugging and unplugging the terminal block 120 into the port 115. In one example, the recess 325 and/or notch 330 allow a user to more securely grip and/or apply force to the terminal block 120. Compared to a flat or completely smooth terminal block 120, the recess 325 and/or notch 330 provide a higher friction surface and/or a more accessible area for the user to pull on the terminal block 120. In another example, the recess 325 and/or notch 330 provide a space to receive a portion of the port 115. For instance, the recess 325 and/or notch 330 is shaped to interface with a particular type of port 115. As shown, the recess 325 is smooth. The notch 330 is formed by multiple flat surfaces arranged at an angle. In an alternate example, the recess 325 and/or notch 330 are shaped and/or positioned in a different way than the FIG. 3 example.

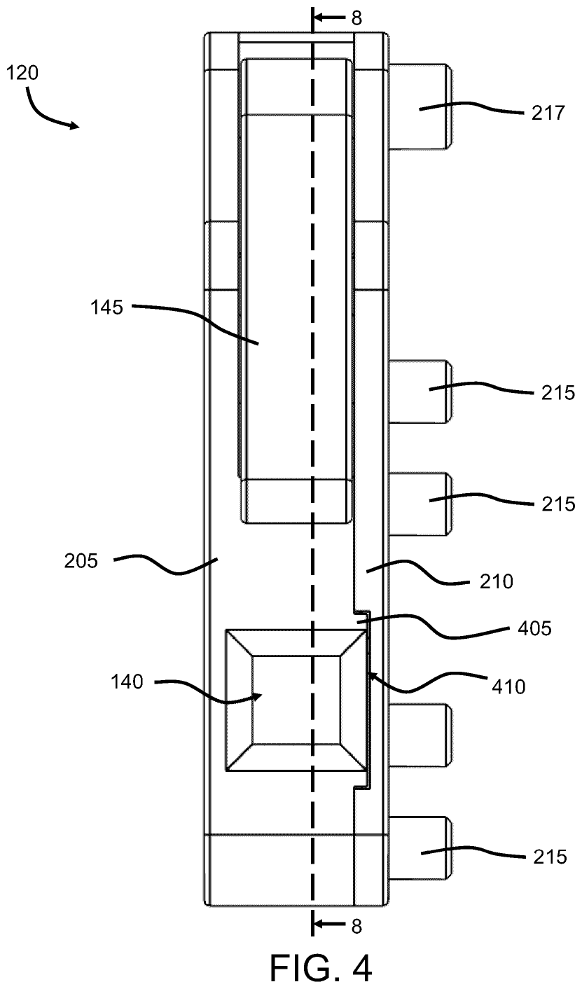

Referring to FIG. 4, the terminal block 120 is configured to be assembled using a tongue and groove joint, dovetail joint, snap-fit joint, and/or another type of connection. The shell 205 and cover 210 are generally configured to be pushed together in a single motion to form the terminal block 120. As illustrated, the terminal block 120 includes a ridge 405 and defines a groove 410. The ridge 405 is a part of the shell 205. The cover 210 defines the groove 410. The groove 410 is configured to receive the ridge 405. The groove 410 is generally shaped to mirror the shape of the ridge 405. The ridge 405 and groove 410 form a tongue and groove joint between the shell 205 and cover 210. The tongue and groove joint limits or fully prevents the shell 205 from sliding relative to the cover 210 in at least one direction. In this way, the tongue and groove joint promotes a strong coupling between the shell 205 and cover 210. In the illustrated example, the ridge 405 and groove 410 are generally rectangular. The rectangular shape allows the cover 210 to slide in a lateral direction relative to the shell 205. In an alternate example, the ridge 405 is trapezoidally shaped and/or wider at a distal portion than at a proximate portion. For instance, the ridge 405 and groove 410 is shaped to form a snap-fit joint and/or a dovetail joint. The snap-fit and/or dovetail joint limits or prevents movement of the cover 210 in a lateral direction relative to the shell 205. As should be appreciated, the terminal block 120 is configured to utilize the ridge 405 and/or groove 410 shaped in another way.

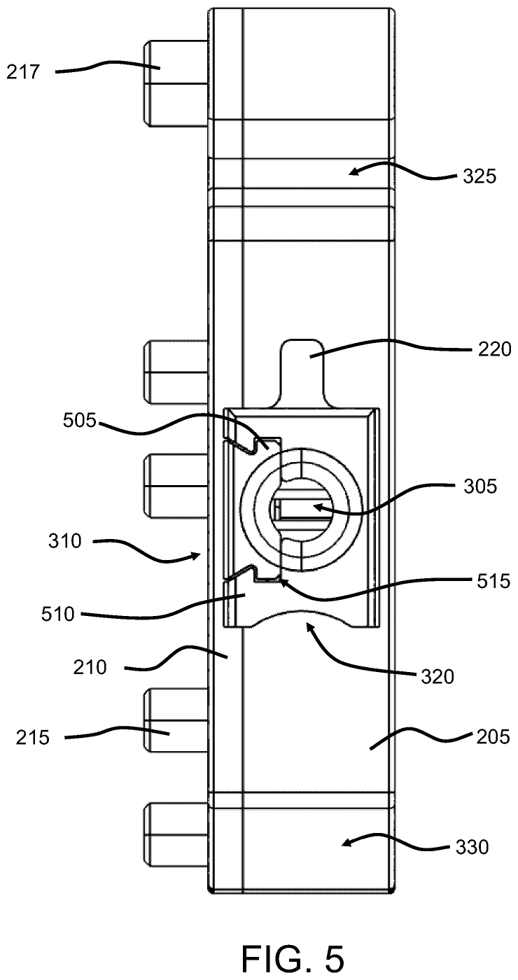

Referring to FIG. 5, the snap-fit connection 310 includes a flange 505 and a clasp 510. The terminal block 120 defines a slot 515 that is utilized in the snap-fit connection 310. The slot 515 is configured to receive the flange 505. The clasp 510 bounds a portion of the slot 515. The clasp 510 is configured to limit or prevent movement of the flange 505. In the illustrated example, the snap-fit connection 310 includes two flanges 505 and two clasps 510. When the terminal block 120 is assembled, the flanges 505 are inserted between the clasps 510. The flanges 505 are configured to push the clasps 510 apart as the flanges 505 move into the slot 515. Once the flanges 505 are positioned within the slot 515, the clasps 510 are configured to return to the original position. The clasps 510 are configured to contact the flanges 505 to lock the pieces together. Generally, the terminal block 120 is made from a mostly rigid material that is flexible to only a small degree. For example, the clasps 510 are flexible enough to bend slightly to accommodate the flanges 505. However, the clasps 510 are rigid enough to maintain the same shape when the flanges 505 are positioned in the slot 515. As illustrated, the clasps 510 are shaped with a slope from an outer to an inner portion. The sloped shape is configured to guide the flanges 505 into the slot 515. Further, by moving the flanges 505 from a wider outer portion to a narrower inner portion, the narrower portion is configured to secure the flanges 505 in place.

As illustrated, the clasps 510 and slot 515 are part of the shell 205. The flanges 505 are part of the cover 210. In another example, one or more clasps 510 and/or flanges 505 are positioned on the shell 205 and/or cover 210 differently. Further, the snap-fit connection 310 is positioned on the plug 130 and defines part of the pin opening 305. Positioning the snap-fit connection 310 near the pin opening 305 creates a strong coupling of the shell 205 and the cover 210. The snap-fit connection 310 supports the shell 205 and cover 210 to maintain the structure of the terminal block 120, particularly at the plug 130. In an alternate embodiment, the snap-fit connection 310 is positioned at another part of the terminal block 120 and/or the terminal block 120 includes one or more additional snap-fit connections 310. Additionally, the snap-fit connection 310 is configured to be arranged in a variety of ways using any number and/or arrangement of the flanges 505 and clasps 510.

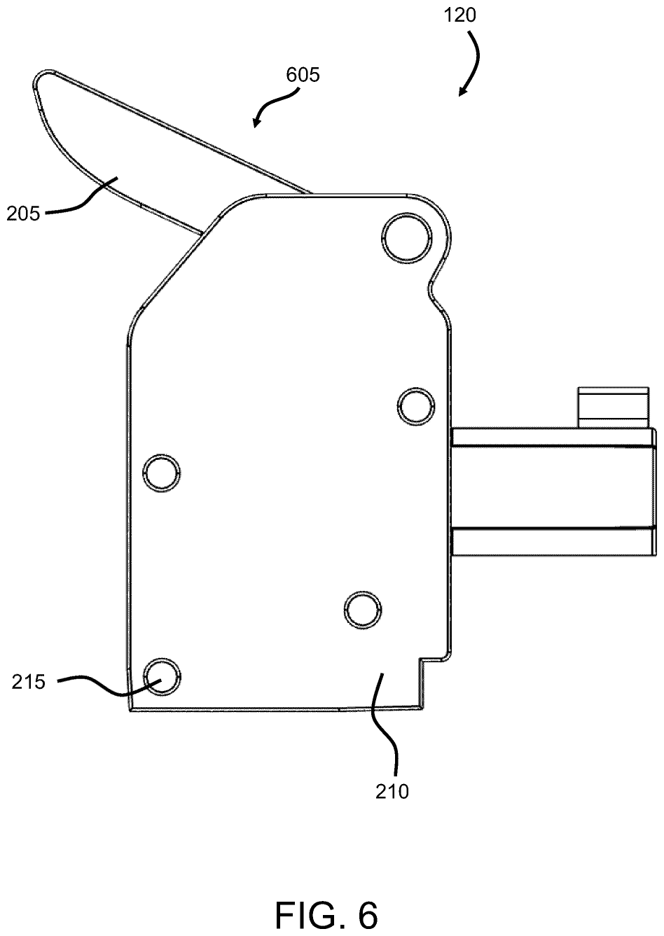

Referring to FIG. 6, the lever 145 is configured to move to an open position 605. When the lever 145 is in the open position 605, the terminal block 120 is configured to release the wire 110 and/or receive the wire 110 through the wire opening 140. The lever 145 is stable in the open position 605 so as to maintain a consistent position. The lever 145 is typically bistable in both the closed position 225 and open position 605. By maintaining the open position 605, the terminal block 120 allows a user to focus on inserting the wire 110 and not on holding the lever 145 in the open position 605. In one example, the lever 145 is biased towards the open position 605 in a certain range of positions. The lever 145 is configured to automatically move to the open position 605 after a user rotates the lever 145 out of the closed position 225. For instance, the lever 145 is biased towards the open position 605 after moving half, two-thirds, or another proportion of the way between the closed position 225 and open position 605. Conversely, the lever 145 is configured to be biased toward the closed position 225 before moving half, one-third, or another proportion between the closed position 225 and open position 605.

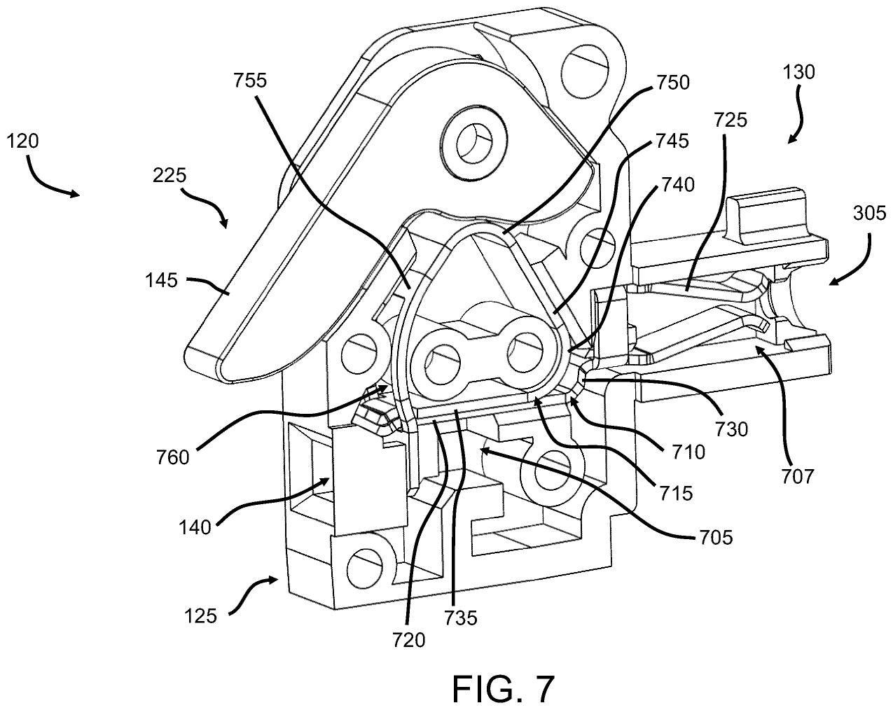

FIG. 7 illustrates an internal view of the terminal block 120 with the cover 210 removed. The terminal block 120 is generally hollow. As illustrated, the terminal block 120 defines a cavity 705 on an interior portion. The cavity 705 generally extends throughout the entire interior of the terminal block 120. The cavity 705 includes a receptacle 707. The receptacle 707 generally extends within the plug 130. In one example, the terminal block 120 is configured to define a single interior space that extends across both the body 125 and plug 130. For example, the cavity 705 and receptacle 707 extend into one another and/or are continuous.

The terminal block 120 includes a busbar 710 and a spring 715. The busbar 710 is configured to electrically connect the wire 110 and the pin 165 on the port 115. The spring 715 is configured to flex between multiple positions. The spring 715 is configured to hold the wire 110 in contact against the busbar 710. By maintaining contact between the wire 110 and busbar 710, the spring 715 is configured to support a reliable electrical connection between the wire 110 and busbar 710. In the illustrated example, the spring 715 is loop-shaped. The spring 715 includes a leaf spring, torsion spring, spiral spring, and/or another type of spring. The busbar 710 and/or spring 715 are formed from a single piece of material. In one example, the busbar 710 and/or spring 715 are formed by cutting and/or bending a sheet of material. The busbar 710 is made of a conductive material, such as copper and/or aluminum. The busbar 710 in one form is coated with a material such as gold and/or platinum. In one example, the spring 715 is made of the same material as the busbar 710. As should be appreciated, the terminal block 120 is configured to utilize a different type and/or shape of busbar 710 and/or spring 715.

The busbar 710 generally includes a strut 720, a socket 725, and a transitional portion 730. The strut 720 is positioned in the cavity 705 within the body 125. The strut 720 is configured to contact the wire 110. For example, the spring 715 is configured to hold the wire 110 against the strut 720. In the illustrated embodiment, the strut 720 is mostly or completely flat. Alternatively, the strut 720 is shaped to at least partially curve toward and/or around the wire 110. The socket 725 is positioned in the receptacle 707 within the plug 130. The socket 725 is configured to contact the pin 165 of the port 115. In one embodiment, the socket 725 is configured to automatically mechanically and electrically couple to the pin 165. For example, the socket 725 is configured to receive and securely contact the pin 165 when a user plugs the terminal block 120 into the port 115. In this way, the socket 725 allows a user to electrically connect the terminal block 120 and port 115 without requiring tools and/or other equipment. The transitional portion 730 is positioned between the strut 720 and socket 725. The transitional portion 730 forms a continuous conduction path between the strut 720 and socket 725. In the illustrated example, the busbar 710 is substantially straight from the strut 720 to the socket 725. For instance, the transitional portion 730 is straight and/or offset below a certain angle relative to the strut 720 and socket 725. In the illustrated example, the transitional portion 730 is offset less than 45 degrees relative to the strut 720 and socket 725. With such a shallow curve and/or offset, the busbar 710 is configured to resist deformation and remain structurally strong as the pin 165 presses against the socket 725. The busbar 710 is generally not at risk to bend and/or deform at any points, such as the transitional portion 730, when the terminal block 120 is plugged in and out of the port 115. In one example, the transitional portion 730 is slightly arched to fit between structural portions of the terminal block 120 and/or to limit movement of the busbar 710.

The spring 715 generally includes a base 735 and a fulcrum 740. The base 735 generally extends along the busbar 710. In one example, the busbar 710 supports spring 715 at the base 735. The fulcrum 740 extends from the base 735. Generally, the spring 715 is configured to the flex at one or more sections and/or points. The fulcrum 740 forms a section where the spring 715 is configured to flex. Rotating the lever 145 is configured to selectively flex and relax the spring 715. In one example, the fulcrum 740 is the same thickness and material as the base 735. In another example, the fulcrum 740 is thinner than the base 735 and/or the base 735 is reinforced to inhibit flexing. In an alternate embodiment, the base 735 is shaped in a different way and/or includes a different material than the rest of the spring 715.

The spring 715 further includes an arm 745, a bend 750, and a leg 755. The arm 745 extends from the fulcrum 740. When the spring 715 flexes at the fulcrum 740, the arm 745 pivots relative to the base 735. In one example, the arm 745 is mostly or completely flat with a consistent thickness. In an alternate example, the arm 745 is curved or shaped in another way. The arm 745 is relatively short compared to a length of the busbar 710 and/or spring 715. By using a relatively short arm 745, the lever 145 must apply a substantial force to compress the spring 715. The substantial force requirement ensures that the spring 715 retains the wire 110 securely and that the spring 715 does not inadvertently release the wire 110. The bend 750 and leg 755 extend from the arm 745. The bend 750 is configured to orient the leg 755 toward the busbar 710. In one example, the bend 750 is configured to flex. For example, when the arm 745 pivots about the fulcrum 740, the bend 750 is configured to flex to maintain a generally consistent orientation of the leg 755. When at rest, the bend 750 defines an angle between the arm 745 and leg 755, for example an angle less than 180 degrees, less than 90 degrees, and/or greater than 45 degrees. In the illustrated example, the leg 755 is curved. The curved shape allows the leg 755 to fit between portions of the terminal block 120. In an alternate example, the arm 745, bend 750, and/or leg 755 are shaped in a different way and/or include a different material than the rest of the spring 715.

The spring 715 defines an aperture 760. In the illustrated example, the aperture 760 is fully enclosed by the leg 755. As illustrated, a portion of the busbar 710 and/or spring 715 extend through the aperture 760. The leg 755 extends around the busbar 710 and base 735. The aperture 760 is configured to receive and surround the wire 110 and/or another electrical conductor.

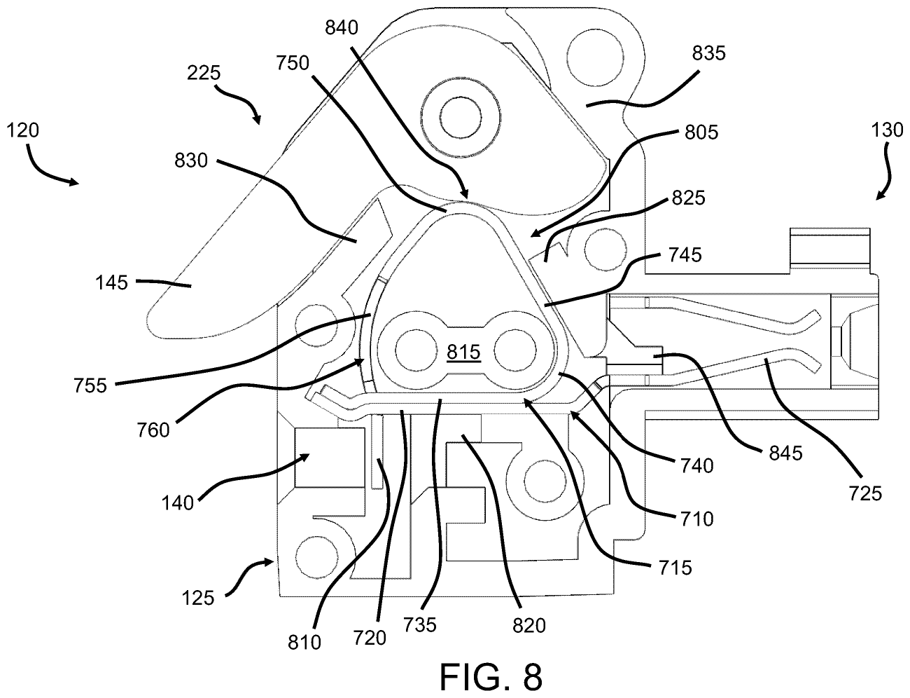

Referring to FIG. 8, the spring 715 is configured to be in a relaxed position 805. Typically, the spring 715 is in the relaxed position 805 when the lever 145 is in the closed position 225. Positioning the lever 145 in the closed position 225 allows the user to relax the spring 715. For example, the lever 145 does not contact and/or apply a force on the spring 715 when in the closed position 225. The relaxed position 805 generally refers to the least compressed arrangement of the spring 715 within the cavity 705 of the terminal block 120. In another example, the lever 145 and/or another part of the terminal block 120 contacts and/or applies a force to the spring 715. In such an example, the compressive force is relatively low and/or the portion of the terminal block 120 abuts the spring 715 without applying a compressive force.

The spring 715 includes a heel 810. The heel 810 extends from the leg 755. When the spring 715 is in the relaxed position 805, the heel 810 is positioned near the wire opening 140. In one example, the heel 810 is configured to block the wire 110 when a user inserts the wire 110 through the wire opening 140. Further, the heel 810 is used to align the leg 755 as the spring 715 compresses. For example, the terminal block 120 is configured to guide the heel 810 as the spring 715 compresses. Guiding the heel 810 in a general direction helps to maintain the orientation of the leg 755.

The terminal block 120 includes one or more internal supports for the busbar 710 and/or spring 715. The internal supports are configured to structurally support, hold in place, guide movement of, and/or support the busbar 710 and/or spring 715 in another way. As illustrated, the terminal block 120 includes a bracket 815, base support 820, spring stopper 825, brace 830, and lever stopper 835 which are configured to function as internal supports. The bracket 815 is generally positioned in the middle of the cavity 705. In the illustrated embodiment, the bracket 815 is positioned within the loop of the spring 715. The bracket 815 is configured to secure the spring 715 in place. Further, the bracket 815 is configured to guide the spring 715 as the spring 715 compresses and decompresses. The bracket 815 is shaped to guide and/or support the fulcrum 740 as the spring 715 flexes. The bracket 815 is shaped to guide the leg 755 as the spring 715 flexes. In one example, the bracket 815 includes one or more rounded portions. An inner radius of the fulcrum 740 is the same or similar to an outer radius of a rounded portion of the bracket 815. In this way, the fulcrum 740 is configured to closely conform to the bracket 815 as the spring 715 flexes.

The base support 820 is positioned below the bracket 815 within the cavity 705. The base support 820 is configured to structurally support the busbar 710 and/or spring 715. In one example, the busbar 710 and/or spring 715 are secured in place between the base support 820 and bracket 815. The base support 820 forms a platform to support the busbar 710 and/or spring 715 from underneath. The spring stopper 825 is positioned near the arm 745. In one example, the spring 715 is secured in place between the bracket 815 and spring stopper 825. The spring stopper 825 is generally aligned with the arm 745 when the spring 715 is in the relaxed position 805. In one example, the spring stopper 825 is configured to contact the arm 745 and limit the range in which the spring 715 is able to flex. For example, the spring stopper 825 is configured to prevent the arm 745 from flexing further away from the transitional portion 730. In the illustrated embodiment, the bracket 815, base support 820 and/or spring stopper 825 form surfaces that mirror or are similar to one or more surfaces on the spring 715.

The brace 830 is positioned near the leg 755. As illustrated, the brace 830 is configured to support the lever 145 in the closed position 225. In one example, the brace 830 is configured to limit the range of rotation for the lever 145. The brace 830 forms a surface that mirrors or is similar to a surface on the lever 145. Further, the brace 830 is configured to guide and/or limit movement of the spring 715. For example, the brace 830 is configured to limit the extent that the leg 755 and/or bend 750 can flex away from the arm 745. In another example, the brace 830 is configured to guide the leg 755 toward the busbar 710 when the spring 715 flexes. The lever stopper 835 is configured to support the lever 145. The lever stopper 835 is positioned across from the brace 830 toward another end of the lever 145. The lever stopper 835 is configured to limit the range of movement of the lever 145 in the closed position 225. The lever stopper 835 forms a surface that mirrors or is similar to a surface on the lever 145. The brace 830 and/or lever stopper 835 are configured to support the lever 145 to maintain a consistent position in the closed position 225. In an alternate example, the brace 830 and/or lever stopper 835 are shaped differently and/or are configured to support the spring 715 and/or lever 145 in different ways.

The lever 145 defines a divot 840. The divot 840 is configured to receive and/or contact a portion of the spring 715. When the lever 145 is in the closed position 225 and the spring 715 is in the relaxed position 805, the divot 840 provides space for the spring 715. Specifically, the divot 840 is configured to provide space for the bend 750. The divot 840 allows the lever 145 to avoid contacting and/or applying a compressive force on the spring 715 in the relaxed position 805. In one example, the divot 840 defines a curve that mirrors or is similar to a curve defined by the bend 750. In another example, the lever 145 contacts the spring 715 but does not apply a compressive force.

The terminal block 120 further includes a ledge 845. The ledge 845 is configured to support the socket 725. In one example, the ledge 845 is configured to secure the position of the socket 725 within the receptacle 707. The ledge 845 in another example defines a surface that mirrors a surface on the socket 725. The ledge 845 is configured to contact the socket 725 along that surface. In another example, the ledge 845 structurally supports the shape of the socket 725. For instance, the ledge 845 is positioned in a space between two sections of the socket 725.

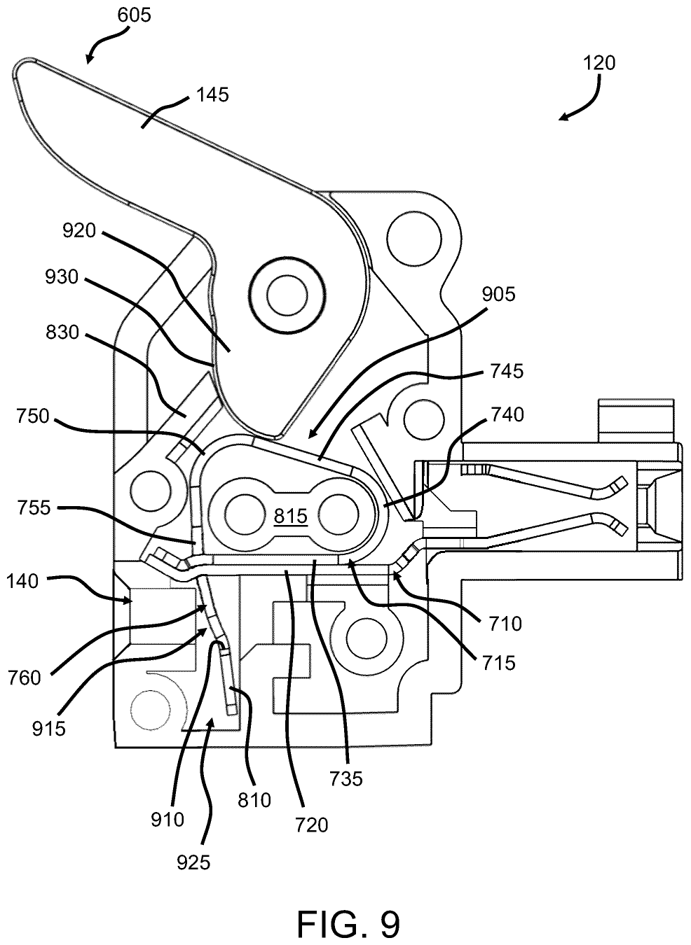

FIG. 9 illustrates the terminal block 120 with the lever 145 in the open position 605. As illustrated, the spring 715 is configured to be in a compressed position 905. Rotating the lever 145 into the open position 605 compresses the spring 715 to the compressed position 905. The arm 745 is configured to rotate toward the base 735 about the fulcrum 740 when the spring 715 is in the compressed position 905. In one example, the spring 715 compresses around the bracket 815. For instance, the fulcrum 740 wraps around the round portion of the bracket 815 as the spring 715 compresses. In another example, the brace 830 contacts and/or guides the leg 755 and/or bend 750 toward the busbar 710 as the spring 715 compresses. Further, the busbar 710 and/or base 735 are configured to maintain the same position as the spring 715 flexes about the fulcrum 740.

The spring 715 further includes an edge 910. The edge 910 is positioned at an end of the aperture 760. The edge 910 extends from the leg 755 and/or heel 810. As the spring 715 compresses, the heel 810 moves away from the busbar 710. Similarly, the aperture 760 is positioned at least partially below the busbar 710 when the spring 715 is in the compressed position 905. With the spring 715 in the compressed position 905, the edge 910 is spaced away from the busbar 710. The edge 910 and the busbar 710 define a gap 915. The gap 915 is a portion of the aperture 760 that is positioned between the busbar 710 and edge 910. The aperture 760 is configured to receive the wire 110 within the gap 915. In the illustrated example, the gap 915 is aligned with the wire opening 140. Aligning the wire opening 140 and gap 915 allows a user to insert the wire 110 through the wire opening 140 and into the gap 915.

The lever 145 includes a tail 920. The tail 920 is configured to contact the spring 715 and apply a compressive force. When a user operates the lever 145 to the open position 605, the lever 145 compresses the spring 715. Specifically, the tail 920 contacts the bend 750 and/or arm 745. One or more portions of the terminal block 120 are configured to limit the range of motion and/or secure the position of the lever 145 in the open position 605. For example, brace 830 is configured to contact the tail 920 to limit movement of the lever 145. In another example, the spring 715 is configured to limit movement of the lever 145. As shown the lever 145 has a dog-legged shape. The tail 920 extends at an angle to the rest of the lever 145. The tail 920 defines a cam surface 930. The cam surface 930 is a surface on the lever 145 configured to contact the spring 715 as the lever 145 compresses the spring 715. The cam surface 930 typically forms a smooth and consistent curve. The smooth curve shape of the cam surface 930 allows the lever 145 to compress the spring 715 in a continuous and controlled motion. In one example, the cam surface 930 is shaped to uniformly contact portions of the arm 745 and/or bend 750 throughout the range of rotation of the lever 145. In an alternate example, the lever 145 and/or tail 920 specifically are shaped and/or arranged differently.

The body 125 defines a pocket 925 that provides clearance for the leg 755 and/or heel 810. The pocket 925 is a portion of the cavity 705 within the body 125. When the spring 715 is in the compressed position 905, the heel 810 is positioned away from the busbar 710. The heel 810 extends into the pocket 925. The heel 810 is not positioned in front of the wire opening 140 when the spring 715 is in the compressed position 905. Moving the heel 810 into the pocket 925 allows the wire 110 to be inserted through the wire opening 140. In one example, the terminal block 120 is shaped to guide the heel 810 into the pocket 925. For instance, the heel 810 is configured to contact a side of the pocket 925 as the spring 715 compresses.

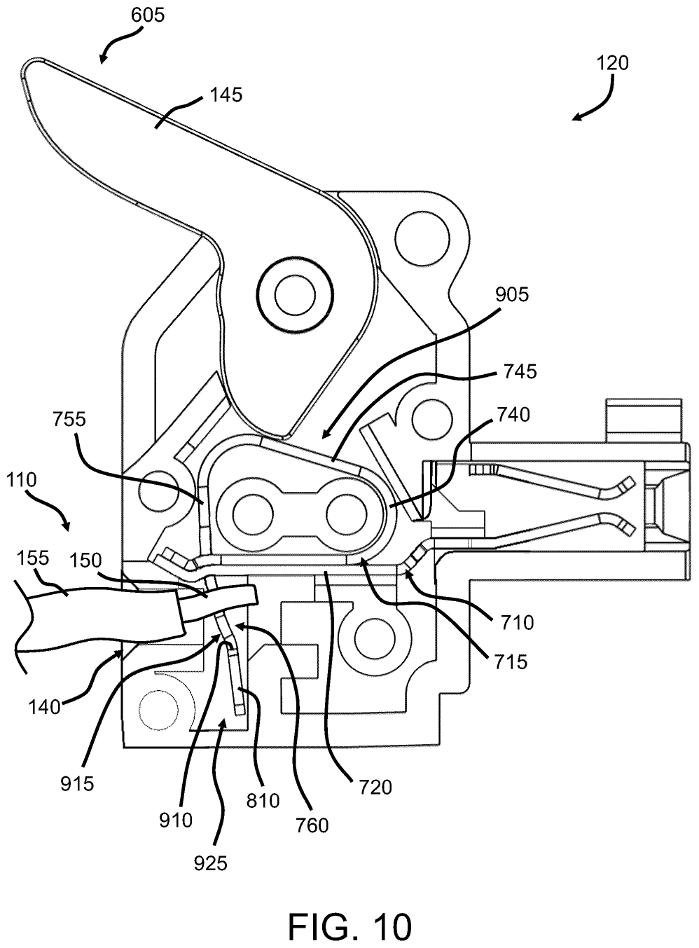

Referring to FIG. 10, the terminal block 120 is configured to receive the wire 110 when the spring 715 is in the compressed position 905 and the lever 145 is in the open position 605. As shown, the wire 110 extends through the wire opening 140. In the illustrated embodiment, the conductive portion 150 is positioned within the aperture 760. In another embodiment, the conductive portion 150 and the insulated portion 155 is positioned within the aperture 760. In the illustrated arrangement, the wire 110 is free to move into and/or out of the aperture 760. As illustrated, the gap 915 expands larger than a width of the wire 110. In one example, the gap 915 is configured to expand up to the size of a 12 AWG conductor and/or another size. By expanding the gap 915 larger than the wire 110, a user can freely insert or remove the wire 110. The user is able to move the lever 145 into the open position 605 where the lever 145 is stable. With the lever 145 in the open position 605, the terminal block 120 allows the user to easily insert a new wire 110, replace an old wire 110, and/or adjust the connection between the wire 110 and the terminal block 120 without the need for additional tools.

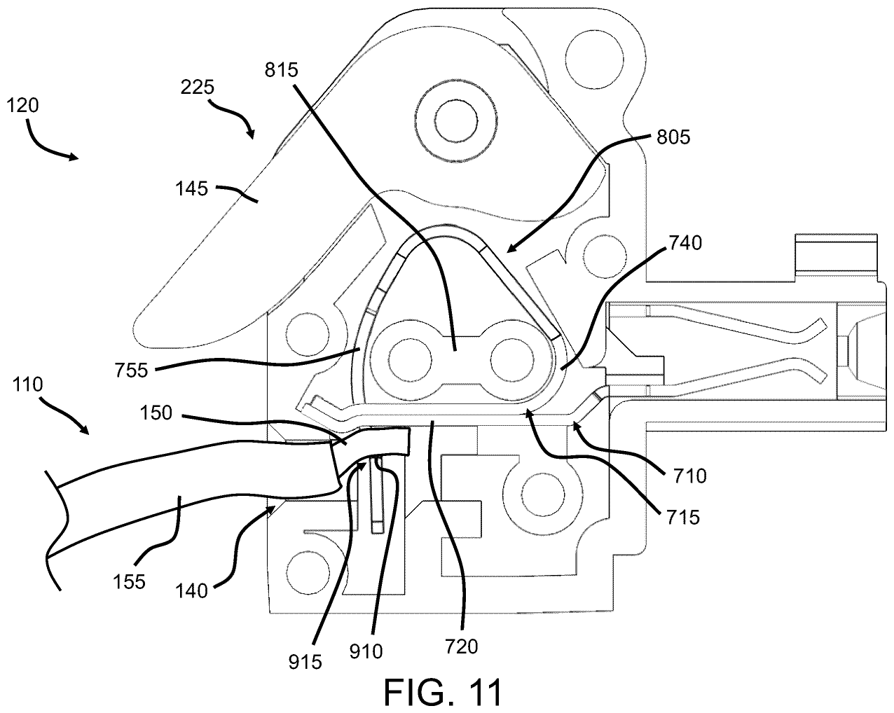

FIG. 11 illustrates the terminal block 120 coupled to the wire 110. As shown, the lever 145 is in the closed position 225. The spring 715 is configured to relax back to the relaxed position 805 with the lever 145 in the closed position 225. After inserting the wire 110 into the terminal block 120, as shown in FIG. 10, a user can rotate the lever 145 into the closed position 225. The spring 715 is configured to secure the wire 110 within the terminal block 120. Specifically, the edge 910 is configured to compress the wire 110 against the strut 720. By compressing the wire 110, the terminal block 120 is configured to mechanically couple to the wire 110 and maintain the position of the wire 110 within the terminal block 120.

By compressing the wire 110 against the busbar 710, the spring 715 electrically connects the wire 110 and the busbar 710. The spring 715 supports a reliable electrical connection between the wire 110 and busbar 710 by securing the position of the wire 110. When the lever 145 is rotated to the closed position 225, the spring 715 returns to the relaxed position 805. The edge 910 moves toward the busbar 710 and reduces the gap 915. The edge 910 compresses the wire 110 against the strut 720. In one example, the spring 715 slightly deforms the conductive portion 150 when coupling to the wire 110. For instance, the edge 910 is configured to bend and/or deform the conductive portion 150 to contact the strut 720. The slight deformation enables the conductive portion 150 to contact the strut 720 across a larger surface area. The shape of the busbar 710 and/or spring 715 is bent toward the wire 110 and/or zigzagged so as to further increase the contact area between the strut 720 and conductive portion 150. Compared to a completely straight bus, the busbar 710 enables a larger surface contact area and therefore lower resistance at the junction between the strut 720 and conductive portion 150. The lever 145 and spring 715 enable a user to reliably electrically connect the wire 110 and terminal block 120 without the need for additional tools.

In the FIG. 11 example, the spring 715 is flexed beyond the relaxed position 805 as shown in FIG. 8. The spring 715 shown in FIG. 11 is still in the relaxed position 805. The relaxed position 805 refers to a general unflexed state of the spring 715. For example, the spring 715 is in the relaxed position 805 when the spring 715 is flexed below a certain amount. For example, the spring 715 is in the relaxed position 805 when the angle between the base 735 and arm 745 about the fulcrum 740 is greater than 30 degrees, 45 degrees, 60 degrees and/or another measure. In another example, the spring 715 is in the relaxed position 805 when the lever 145 does not exert a force on the spring 715 and/or is in the closed position 225. The relaxed position 805 generally refers to a range of possible orientations for the spring 715. Conversely, the spring 715 is in the open position 605 when the lever 145 compresses the spring 715 beyond a certain point and/or is in the open position 605.

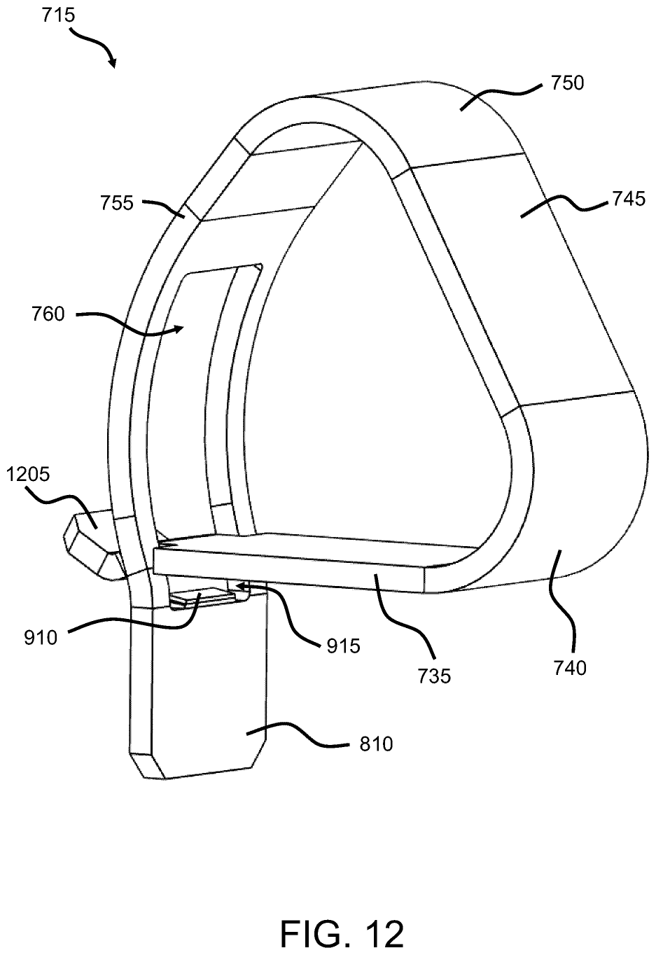

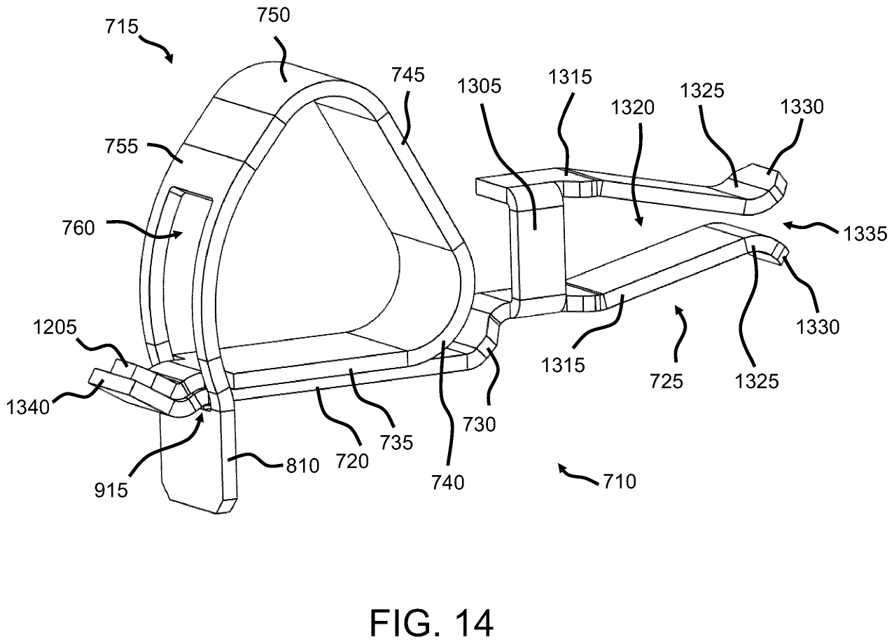

Referring to FIGS. 12, 13, and 14, views of the busbar 710 and spring 715 are illustrated. The busbar 710 and spring 715 are each formed from a single piece of material. For example, the busbar 710 and spring 715 are each formed by cutting and/or bending a sheet of material. In one example, the busbar 710 includes few bends and/or bends below a certain angle. The low amount of bending in the busbar 710 supports structural stability of the busbar 710. The spring 715 is generally loop-shaped. In one example, the loop of the spring 715 is formed from combinations of straight and curved segments. In another example, the loop is roughly triangular. Alternatively, the spring 715 is configured to form a loop in any other type of shape. In one example, the base 735, fulcrum 740, arm 745, bend 750, and/or leg 755 are formed from any combination of straight and curved segments. In the illustrated embodiment, the spring 715 further includes a spring guide 1205. The spring guide 1205 is positioned within the aperture 760. The spring guide 1205 is configured to maintain the alignment of the leg 755 as the spring 715 flexes. The spring guide 1205 ensures reliable operation of the spring 715. Similarly, the busbar 710 includes a bus guide 1340. As shown in FIG. 14, the bus guide 1340 is positioned through the leg 755 and functions in a similar way to the spring guide 1205. The angled and/or zigzag shape of the spring guide 1205 and bus guide 1340 are configured to interface. By interfacing, the spring guide 1205 and bus guide 1340 are configured to help maintain the position of the spring 715 relative to the busbar 710. Further, the angle of the bus guide 1340 generally extends toward the wire 110 when the wire 110 is positioned in the terminal block 120. By angling toward the wire 110, the bus guide 1340 is configured to provide a greater contact area between the busbar 710 and wire 110 compared to a non-angled bus.

As shown in FIG. 12, the spring 715 defines the gap 915 between the edge 910 and the base 735. In one example, the gap 915 is the same width as the strut 720 of the busbar 710. When the busbar 710 and spring 715 are assembled together in the relaxed position 805, the edge 910 is configured to contact the strut 720. In such an example, the gap 915 is effectively fully closed. In an alternate example, the edge 910 is spaced a distance away from the strut 720 when the spring 715 is in the relaxed position 805. For example, the gap 915 with the spring 715 in the relaxed position 805 is at least the size of a 24 AWG conductor and/or another size wire. The size of the gap 915 in the relaxed position 805 determines the minimum conductor size the spring 715 is configured to couple to the busbar 710.

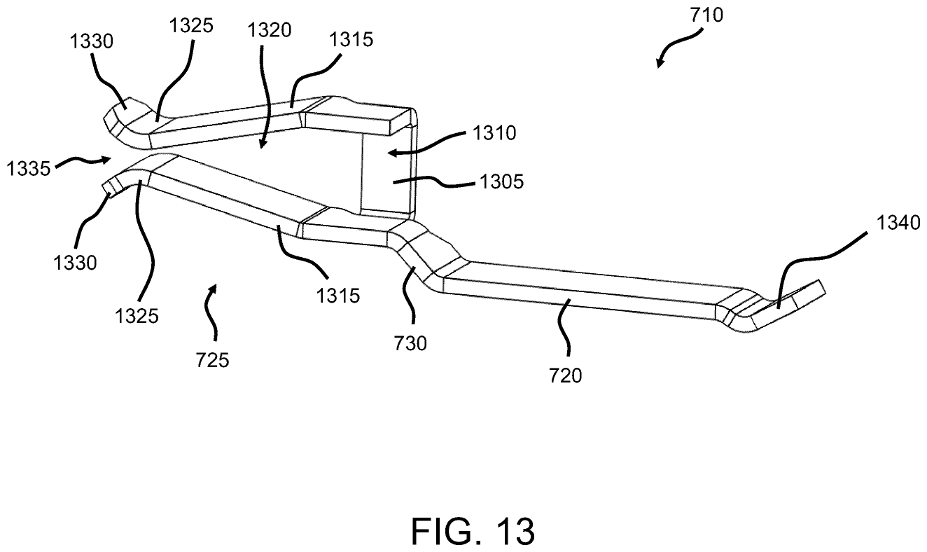

As shown in FIG. 13, the socket 725 generally includes a bridge 1305, leaves 1315, arches 1325, and lips 1330. The bridge 1305 extends from the transitional portion 730. The bridge 1305 is generally c-shaped. The bridge 1305 is configured to space the leaves 1315 apart. The bridge 1305 defines a bridge space 1310. The bridge space 1310 is configured to receive the ledge 845, shown in FIG. 8. In the terminal block 120, the ledge 845 is positioned within the bridge space 1310 to support the socket 725. In the illustrated example, the bridge 1305 is oriented in a vertical direction. By orienting the bridge space 1310 in a vertical direction, the busbar 710 is able to be inserted directly into the shell 205 during assembly. For example, the vertical orientation and c-shape of the bridge 1305 enables the bridge space 1310 to be inserted against the ledge 845 during assembly. The shape of the busbar 710 and shell 205 enables the busbar 710 to be inserted into the cavity 705 using a single motion. Inserting the busbar 710 into the shell 205 in this way supports quick and reliable assembly of the terminal block 120.

The bridge 1305 splits into two leaves 1315. The leaves 1315 extend away from the transitional portion 730. In the illustrated embodiment, the leaves 1315 are at least partially angled toward one another. In one example, the leaves 1315 extend parallel to one another for a certain length and then angle towards each other. Alternatively, the shape and/or orientation of the leaves 1315 could be varied in a different way. Each leaf 1315 extends into an arch 1325. Each arch 1325 curves away from the other arch 1325. As shown, the arches 1325 curve away from one another to stop the leaves 1315 from extending into one another. In one example, the arches 1325 are spaced apart by some distance. In an alternate example, the arches 1325 contact one another. The arches 1325 transition into the lips 1330. Each lip 1330 bends away from the opposite lip 1330. The shape of the socket 725 is configured to guide the pin 165 between the leaves 1315. The arches 1325 are configured to compress the pin 165 to secure the pin 165 in place. In an alternate embodiment, the shape of the socket 725 is varied. For example, the leaves 1315 extend fully parallel to one another and the arches 1325 curve inward towards one another.

The socket 725 defines a pin receptacle 1320 between the leaves 1315. The pin receptacle 1320 provides a space for the pin 165 to be positioned when the terminal block 120 is coupled to the port 115, shown in FIG. 1. As should be appreciated, the pin receptacle 1320 is further configured to receive another type of conductor, such as the wire 110. The pin receptacle 1320 extends between the bridge 1305, leaves 1315, and arches 1325. When the pin 165 is positioned within the pin receptacle 1320, the arches 1325 are configured to contact the insulated portion 155. The socket 725 is configured to mechanically couple to the pin 165. For example, the arches 1325 are configured to compress and contact the pin 165. By contacting the pin 165, the socket 725 is configured to electrically connect to the pin 165.

The socket 725 further defines a mouth 1335 between the lips 1330. The mouth 1335 provides a space for the pin 165 as the pin 165 enters the pin opening 305. When the pin 165 contacts the lips 1330 and/or arches 1325, the leaves 1315 are configured to bend apart to accommodate the insulated portion 155. The curved and/or angled shape of the arches 1325 and lips 1330 encourages the arches 1325 to bend apart as the pin 165 is inserted. The socket 725 is generally rigid such as to broadly maintain the same shape. However, the socket 725 is configured to bend apart slightly to receive the pin 165. The generally rigid nature of the socket 725 enables the socket 725 to reliably couple to the pin 165. In this way, the terminal block 120 enables a user to reliably electrically and mechanically connect the port 115 to the terminal block 120 without tools.

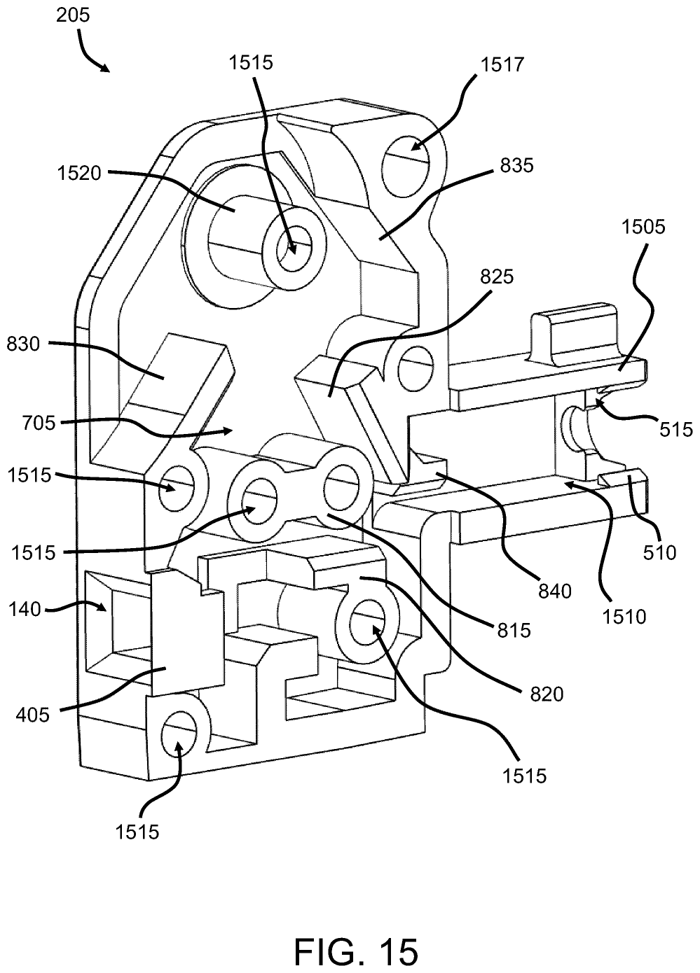

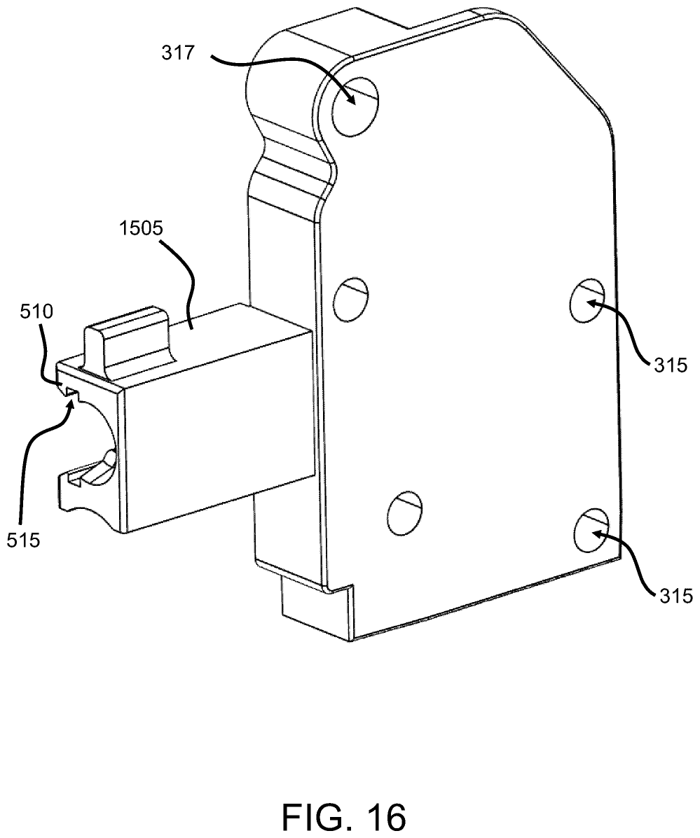

Referring to FIGS. 15 and 16, views of the shell 205 are illustrated. The shell 205 is formed as a single piece of material. For example, the shell 205 is formed using injection molding and/or another technique. Generally, the shell 205 forms a border around the cavity 705. The outer border of the shell 205 is formed by the ridge 405, spring stopper 825, brace 830, lever stopper 835, and/or other portions of the shell 205. One lateral side of the shell 205 is generally open. Using an open side on the shell 205 supports quick and reliable manufacturing of the terminal block 120. For instance, the open side allows the shell 205 to receive the busbar 710 and spring 715 in one motion. In an alternate embodiment, the shape and/or position of one or more portions of the shell 205 is modified.

The shell 205 further includes a plug frame 1505. The plug frame 1505 forms most of the structure of the plug 130. The plug frame 1505 defines a slot 1510. The slot 1510 is configured to receive a portion of the cover 210. The plug frame 1505 and slot 1510 are configured to align the cover 210 and the shell 205. In one example, the plug frame 1505 aligns the snap-fit connection 310 between the shell 205 and cover 210. Specifically, the plug frame 1505 is configured to align the flanges 505 on the cover 210 between the clasps 510 and into the slot 515 on the shell 205. The structure of the shell 205 is configured to facilitate assembling the shell 205 and cover 210. The plug frame 1505 facilitates coupling the shell 205 and cover 210 at the snap-fit connection 310.

The shell 205 defines one or more internal holes 1515. The internal holes 1515 are configured to receive a portion of the cover 210. The cover 210 and shell 205 are configured to couple using the internal holes 1515. As illustrated, one or more internal holes 1515 extend fully through the shell 205. One or more internal holes 1515 are the same opening as the holes 315. Using holes 315 that extend fully through the shell 205 generally facilitates manufacturing and/or assembling the terminal block 120. For example, extending the holes 315 fully through the shell 205 enables the shell 205 to be formed and/or released from a mold quickly and reliably. Conversely, one or more internal holes 1515 extend only partly through the shell 205. Defining too many holes 315 through the shell 205 generally weakens the structural integrity of the shell 205. By only defining some holes 315 through the shell 205, the shell 205 is configured to be as strong or nearly as strong as a solid piece with no holes. As illustrated, the bracket 815 defines two internal holes 1515. The internal holes 1515 in the bracket 815 form multiple round portions. As shown in FIGS. 8 and 9, the fulcrum 740 of the spring 715 is configured to wrap around the round shape of the bracket 815. The size and/or placement of the internal holes 1515 is configured to correspond to the shape of the spring 715. The terminal block 120 further defines an internal hole 1515 through the brace 830. The internal hole 1515 affects part of the shape of the brace 830. The round shape of the brace 830 is configured to guide the spring 715 when flexing. Further, the shell 205 defines a stud hole 1517. The stud hole 1517 extends from the dowel hole 317. In an alternate embodiment, the placement and/or size of one or more internal holes 1515 is varied from the illustrated embodiment.

The shell 205 further includes a lever pivot 1520. The lever pivot 1520 is generally cylindrically shaped. The lever 145 is configured to pivot about the lever pivot 1520. The lever pivot 1520 is rotatably coupled to the lever 145 in the assembled terminal block 120. In the illustrated example, the lever pivot 1520 defines an internal hole 1515. The internal hole 1515 supports a coupling point between the shell 205 and cover 210. By coupling the shell 205 and cover 210 at the lever pivot 1520, the terminal block 120 is configured to secure the lever 145 within the terminal block 120. The lever pivot 1520 supports reliable operation of the lever 145 between the closed position 225 and relaxed position 805.

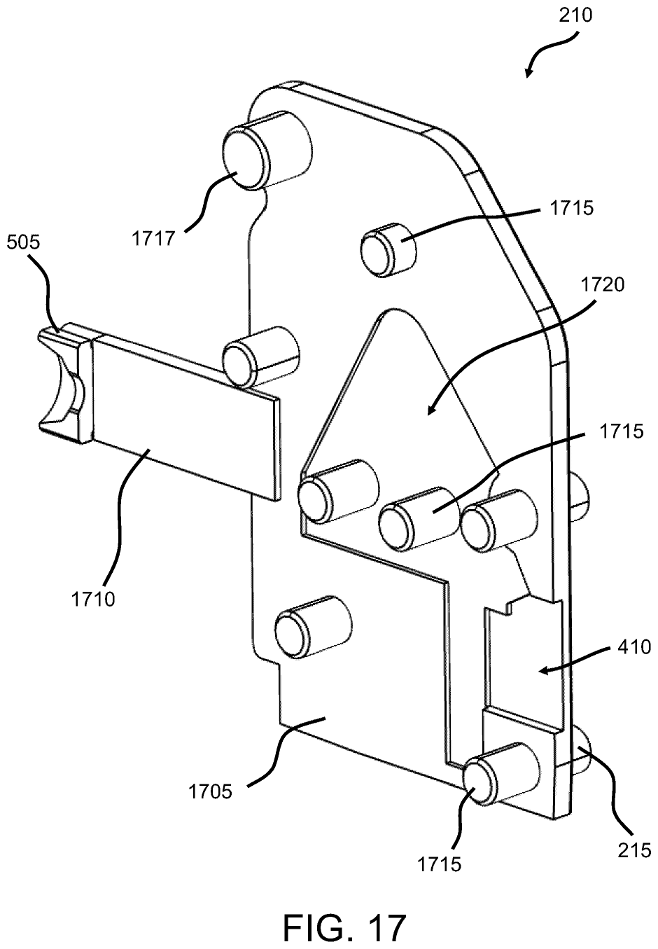

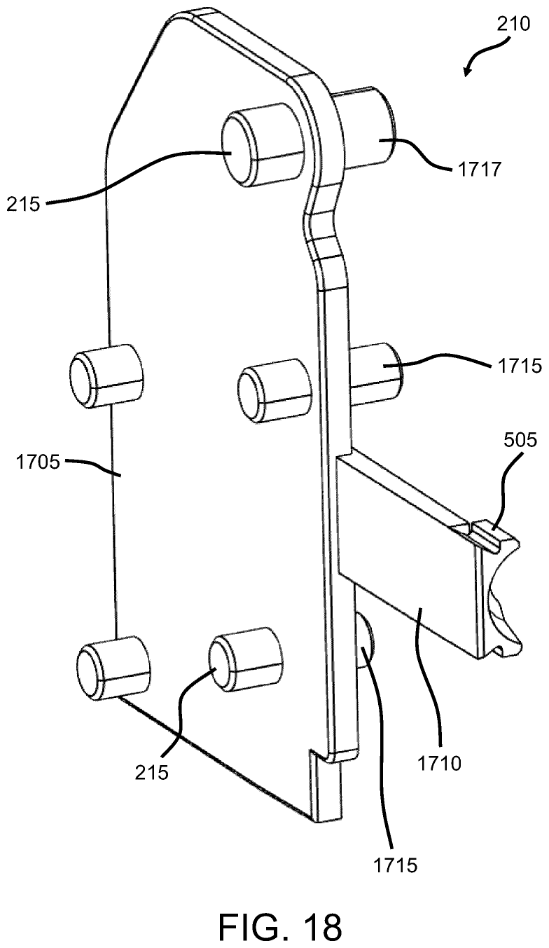

Referring to FIGS. 17 and 18, isolated views of the cover 210 are illustrated. Similar to the shell 205, the cover 210 is typically formed as a single piece of material. For example, the cover 210 is formed using injection molding and/or another technique. The cover 210 generally forms a flat shape that is configured to cover the cavity 705 of the shell 205. The shape of the cover 210 supports quick, simple, and/or reliable manufacturing of the terminal block 120. For example, the cover 210 configured to couple to the shell 205 in one motion after the busbar 710 and spring 715 are positioned in the cavity 705.

The cover 210 includes a panel 1705 and a plug strut 1710. The panel 1705 forms the main section of the cover 210. The panel 1705 is generally a flat sheet of material. The panel 1705 is configured to cover the cavity 705 of the shell 205. The plug strut 1710 extends away from the panel 1705. The plug strut 1710 is configured to cover the receptacle 707 of the shell 205. The slot 1510 is configured to receive the plug strut 1710. The plug frame 1505 is configured to guide and align the plug strut 1710. Specifically, the plug strut 1710 and plug frame 1505 are configured to align the snap-fit connection 310 between the shell 205 and cover 210. The plug strut 1710 is configured to align the flanges 505 with the clasps 510 and slot 515 on the shell 205. In one example, the plug strut 1710 is configured to function as a cantilever to support the snap-fit connection 310.

The cover 210 further includes one or more internal pegs 1715. The internal pegs 1715 are configured to couple to the internal holes 1515 on the shell 205. The internal holes 1515 are configured to receive the internal pegs 1715. In one example, the internal pegs 1715 and internal holes 1515 are configured to frictionally couple. In another example, the internal pegs 1715 and the internal holes 1515 are configured to align the shell 205 and cover 210. One or more internal pegs 1715 are aligned with pegs 215. Such pegs 215 effectively extend on both sides of the cover 210. Extending the pegs 215 on both sides of the cover 210 generally facilitates manufacturing the cover 210. For example, extending the pegs 215 on both sides allows the cover 210 to form and/or release from a mold quickly and reliably. The positions and sizes of the internal pegs 1715 correspond to the positions and sizes of the internal holes 1515 on the shell 205. Further, the cover 210 includes a stud 1717. The stud 1717 is generally larger than the internal pegs 1715 and is an extension of the dowel 217. The stud hole 1517 is configured to receive the stud 1717 and to couple to the stud 1717 through friction. By positioning the stud 1717 and stud hole 1517 near the lever 145, the terminal block 120 is configured to allow the lever 145 to rotate consistently. In an alternate example, the size and/or arrangement of the internal holes 1515 and/or internal pegs 1715 are altered.

The cover 210 defines a spring recess 1720. The spring recess 1720 is generally shaped to match an outline of the spring 715. For example, the spring recess 1720 defines a space for the loop portion of the spring 715 and defines a space for the leg 755 and heel 810 that extend away from the loop. The spring recess 1720 is configured to guide the spring 715 as the spring 715 flexes. In one example, the spring recess 1720 enables the shell 205 and cover 210 to fit together more securely.

As illustrated in FIGS. 15 through 17, the shell 205 and cover 210 include many interlocking parts. The terminal block 120 is configured to be assembled using one or more snap-fit joints, tongue and groove joints, friction fits, and/or other coupling techniques. For example, the flange 505, clasp 510, and slot 515 form the snap-fit connection 310. As another example, the ridge 405 and groove 410 form a tongue and groove joint. Further, the plug strut 1710 and plug frame 1505 form a tongue and groove joint. As yet another example, the internal holes 1515 and internal pegs 1715 form friction fits between the shell 205 and cover 210. As should be appreciated, the shell 205 and cover 210 are configured to be coupled in any variety of ways. Further, the shell 205 and cover 210 are configured to be formed using injection molding and/or another manufacturing process. The shell 205 and cover 210 are generally shaped to facilitate removing the shell and cover from molds. For example, the shell 205 and cover 210 are configured to quickly release from molds in a single motion.

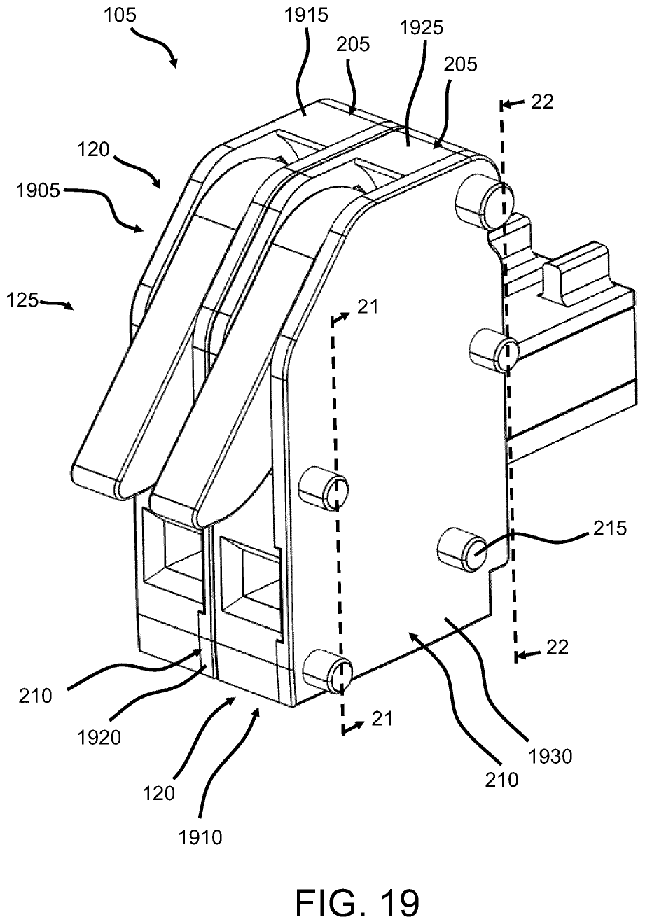

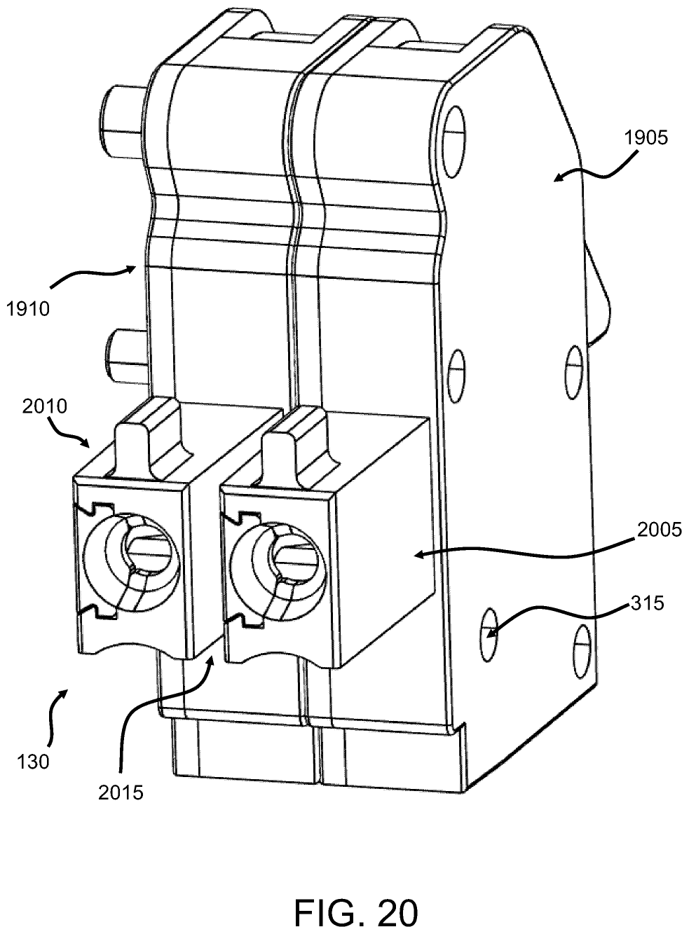

Referring to FIGS. 19 and 20, the terminal block assembly 105 is illustrated. As shown in FIG. 1, the terminal block assembly 105 includes one or more terminal blocks 120. In one example, the terminal block assembly 105 includes two terminal blocks 120. In an alternate example, the terminal block assembly 105 includes more than two terminal blocks 120. The terminal blocks 120 are configured to couple to at least one other terminal block 120 on each side. By coupling to another terminal block 120 on each side, the terminal blocks 120 are configured to couple in a chain of any length. The terminal blocks 120 support the terminal block assembly 105 to be any size. The terminal block assembly 105 allows a user to set a custom size using a desired number of terminal blocks 120. For example, the user can assemble the terminal block assembly 105 using a number of terminal blocks 120 that corresponds to the number of wires 110 needed and/or the number of ports on the port 115. Further, the connector system 135 is configured to align the terminal blocks 120 in the terminal block assembly 105. As shown in FIGS. 2 and 3, the pegs 215 and holes 315 are arranged such that the terminal blocks 120 only couple in one orientation. The arrangement ensures that the terminal blocks 120 are aligned when forming the terminal block assembly 105.

In the FIG. 19 example, the terminal block assembly 105 includes a first terminal block 1905 and a second terminal block 1910. In one embodiment, the first terminal block 1905 and second terminal block 1910 are identical parts. In an alternate embodiment, the first terminal block 1905 and second terminal block 1910 have one or more differences. For example, the first terminal block 1905 omits the exterior holes 315 and/or the second terminal block 1910 omits the exterior pegs 215. The first terminal block 1905 and second terminal block 1910 are both configured to selectively couple to wires 110 using the lever 145 and spring 715. The first terminal block 1905 and second terminal block 1910 are both configured to couple to the port 115 in a pluggable manner. The first terminal block 1905 and second terminal block 1910 generally include the same internal components, such as the busbar 710 and spring 715 as shown in FIG. 14.

As illustrated, the first terminal block 1905 includes a first shell 1915 and a first cover 1920. Similarly, the second terminal block 1910 includes a second shell 1925 and a second cover 1930. The first shell 1915 and second shell 1925 are the same as the shell 205 in FIG. 15. The first cover 1920 and second cover 1930 are the same as the cover 210 in FIG. 17. In an alternate embodiment, the first terminal block 1905 and/or second terminal block 1910 include one or more different parts from the terminal block 120 in FIG. 2. The first cover 1920 is configured to contact the second shell 1925 in the illustrated example. The first cover 1920 sits flush against the second shell 1925. The terminal block assembly 105 generally forms a single continuous body 125 among the multiple terminal blocks 120. The first terminal block 1905 further includes a first plug 2005. The second terminal block 1910 further includes a second plug 2010. The first plug 2005 and second plug 2010 are generally the same as the plug 130 in FIG. 2. As illustrated, the first plug 2005 and second plug 2010 define a plug gap 2015. The terminal block assembly 105 does not include a continuous plug 130. In one example, the first plug 2005 and second plug 2010 form the plug gap 2015 to correspond to the shape of the plug opening 160 in the port 115. For example, the port 115 defines multiple distinct plug openings 160 that each are configured to receive one plug 130. Using multiple plugs 130 separated by the plug gap 2015 can enforce the coupling between the terminal block assembly 105 and the port 115.

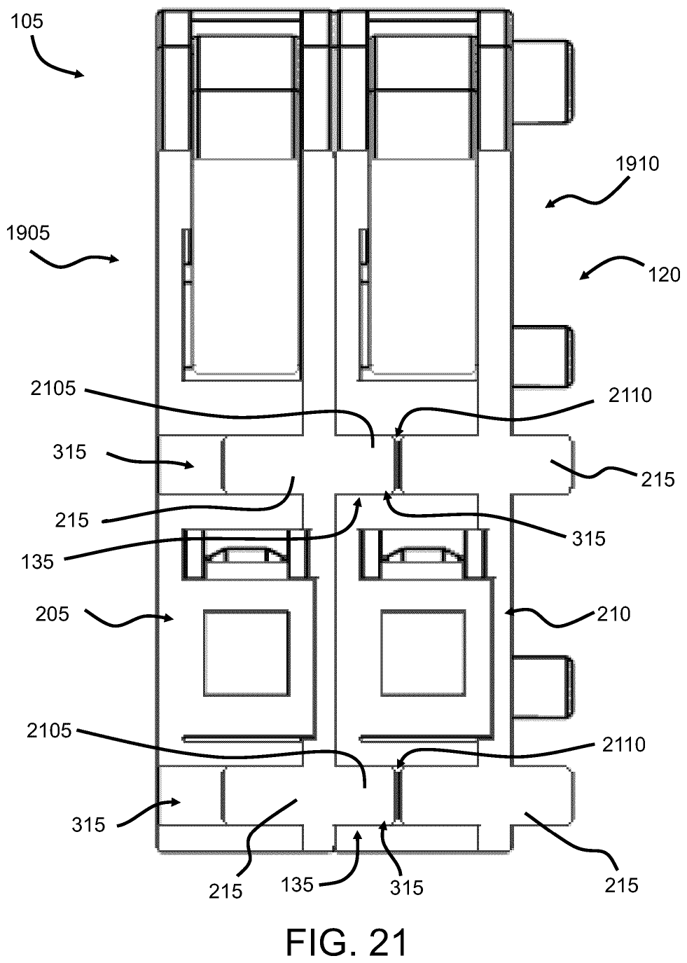

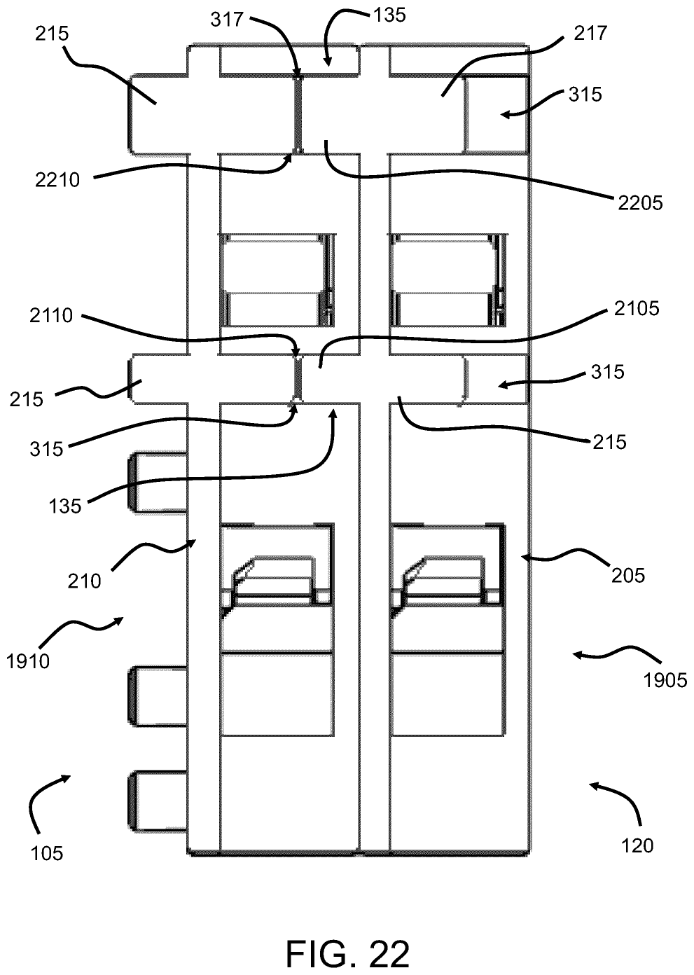

FIGS. 21 and 22 illustrate cross-sectional views of the terminal block assembly 105. The pegs 215 on the first terminal block 1905 include first block pegs 2105 including a first block dowel 2205. The holes 315 on the second terminal block 1910 include second block holes 2110 including a second block hole 2210. As illustrated, the holes 315 on one terminal block 120 are configured to receive the pegs 215 of another terminal block 120. Specifically, the second block holes 2110 are configured to receive the first block pegs 2105. In one example, the first block pegs 2105 and second block holes 2110 couple through friction. Similarly, the dowel hole 317 on one terminal block 120 is configured to receive the dowel 217 of another terminal block 120. The second block hole 2210 is configured to receive the first block dowel 2205. The dowel 217 and dowel hole 317 are generally configured to couple with greater force between the terminal blocks 120 compared to the other pegs 215 and holes 315.

As illustrated, the holes 315 extend fully through the shells 205. Similarly, the pegs 215 extend on each side of the covers 210. The pegs 215 effectively extend through the covers 210. The holes 315 are configured to receive the pegs 215 from multiple terminal blocks 120. The pegs 215 are configured to couple to holes 315 on multiple terminal blocks 120. The design of the shell 205 and cover 210 facilitate manufacturing and assembling the terminal block 120 and terminal block assembly 105. The additional coupling mechanisms between the shell 205 and cover 210 enable the terminal block 120 to remain assembled when connecting and disconnecting multiple terminal blocks 120. For example, the snap-fit connection 310 ensures that the shell 205 and cover 210 in one terminal block 120 remain coupled when disconnecting pegs 215 and holes 315 on two terminal blocks 120.

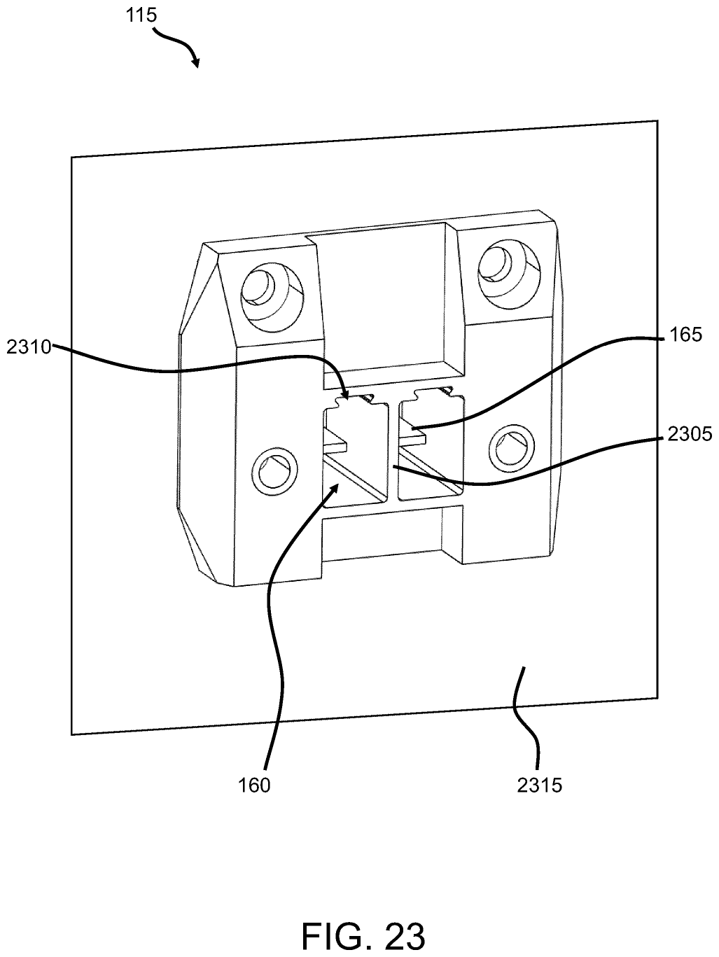

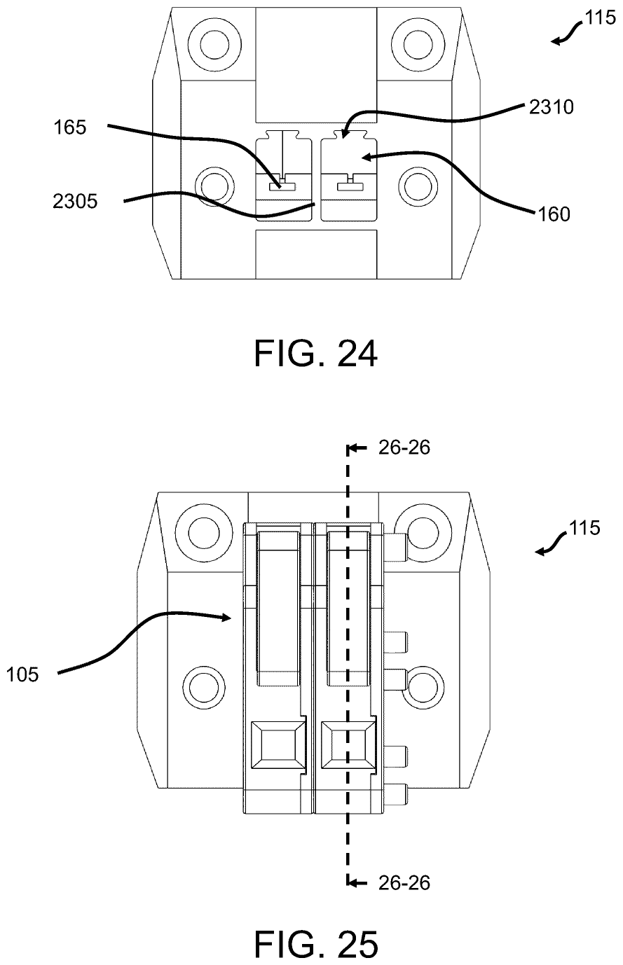

FIGS. 23 and 24 illustrate the port 115. As shown in FIG. 1, the port 115 defines one or more plug openings 160 and includes one or more pins 165. The port 115 further includes a divider 2305. The divider 2305 is configured to separate multiple plug openings 160. Further, the divider 2305 is configured to support the terminal block 120 when coupled to the port 115. For example, the divider 2305 is configured to limit rotation and/or lateral movement of the plug 130 within the plug opening 160. The plug opening 160 includes a rut 2310. The rut 2310 is generally narrower than the rest of the plug opening 160. The rut 2310 extends on an upper portion of the plug opening 160. The rut 2310 is configured to receive the fin 220, as shown in FIG. 2. Positioning the fin 220 within the rut 2310 supports the connection between the terminal block 120 and the port 115. For example, the fin 220 and rut 2310 are configured to limit rotation and/or lateral movement of the plug 130 within the plug opening 160.

The port 115 is generally mounted to and/or part of a device 2315. The device 2315 can be a stereo system, a speaker system, and/or any other type of device. In an alternate example, the device 2315 includes a wall and/or another structure. For example, the port 115 is mounted on a wall and is indirectly connected to another device through in-wall cables. The terminal block assembly 105 is configured to facilitate wiring devices together in a variety of home, commercial, and/or other settings.

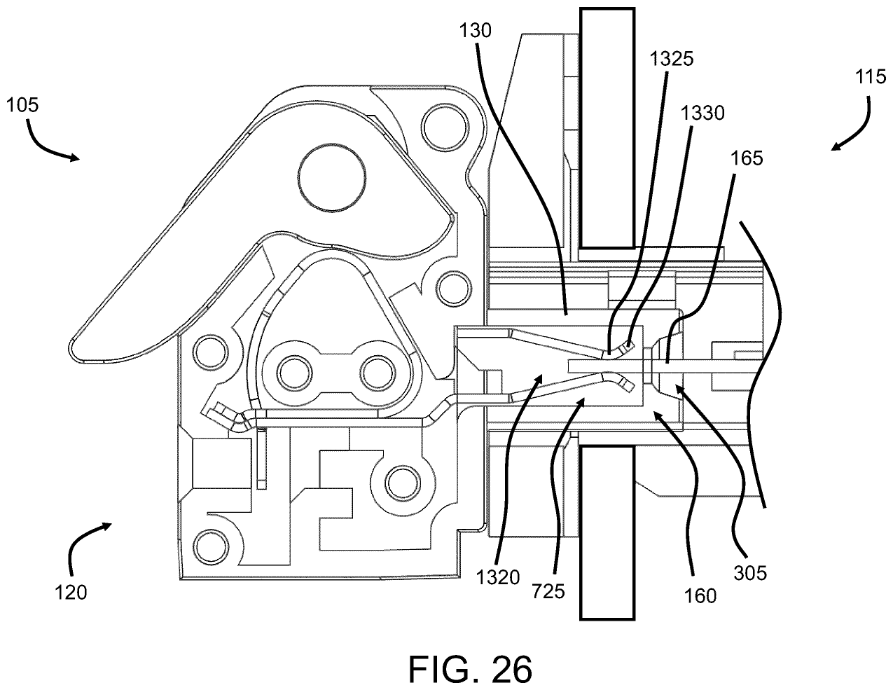

FIGS. 25 and 26 illustrate the terminal block assembly 105 coupled to the port 115. As illustrated, the pin 165 is configured to extend through the pin opening 305. The plug 130 is configured to be positioned within the plug opening 160. In one example, the port 115 is configured to secure the position of the plug 130 within the plug opening 160. Securing the plug 130 ensures reliable contact between the pin 165 and the socket 725. In another example, the socket 725 is configured to secure the position of the pin 165. Securing the pin 165 ensures reliable contact between the socket 725 and pin 165. Further, securing the pin 165 ensures the reliable connection between the terminal block 120 and port 115.

As illustrated, the pin 165 is configured to extend into the pin receptacle 1320. The pin receptacle 1320 provides space for the pin 165. In one example, the pin receptacle 1320 is configured to receive the pin 165 in sizes corresponding between 12 AWG and 24 AWG. The arches 1325 are configured to contact and compress the pin 165. In one example, a gap between the arches 1325 is the same as a width of the pin 165. In another example, a gap between the arches 1325 is less than a width of the pin 165. When the plug 130 receives the pin 165, the pin 165 is configured to flex the arches 1325 apart slightly. Spacing the arches 1325 slightly less than the size of the pin 165 enables the socket 725 to compress the pin 165. In one example, the pin 165 is configured to maintain a consistent shape as the socket 725 compresses the pin 165. Alternatively, the socket 725 could deform the pin 165 slightly when coupling. Further, the lips 1330 provide a space for the pin 165 as the pin 165 enters through the pin opening 305. The lips 1330 are configured to facilitate the socket 725 receiving the pin 165. The lips 1330 are configured to guide the pin 165 between the arches 1325 and leaves 1315. The lips 1330 and arches 1325 are also configured to push the leaves 1315 apart when receiving the pin 165. In this way, the socket 725 and plug 130 are configured to support a reliable and secure electrical connection to between the terminal block 120 and the port 115. The terminal block 120 and port 115 are configured to electrically and mechanically connect without the need for tools and/or other equipment.

### GLOSSARY OF TERMS

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“American Wire Gauge (AWG)” generally refers to a logarithmic stepped standardized wire gauge system referring to the diameters of round, solid, nonferrous, electrically conducting wire. Dimensions of the wires are given in ASTM standard B258. Increasing gauge numbers denote decreasing wire diameters. The AWG tables are for a single, solid, round conductor. The AWG of a stranded wire is determined by the cross-sectional area of the equivalent solid conductor. Because there are also small gaps between the strands, a stranded wire generally has a slightly larger overall diameter than a solid wire with the same AWG.

“And/Or” generally refers to a grammatical conjunction indicating that one or more of the cases it connects may occur. For instance, it can indicate that either or both of the two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Bracket” generally refers to a flat or curved component that forms part of another object. Typically, but not always, the bracket has a generally flat shape.

“Cavity” generally refers to an empty space in a solid object. The cavity can be completely or partially surrounded by the solid object. For example, the cavity can be opened to the surrounding environment.

“Conductor” or “Conductive Material” generally refers to a material and/or object that allows the free flow of an electrical charge in one or more directions such that relatively significant electric currents will flow through the material under the influence of an electric field under normal operating conditions. By way of non-limiting examples, conductors include materials having low resistivity, such as most metals (e.g., copper, gold, aluminum, etc.), graphite, and conductive polymers.

“Couple” or “Coupled” generally refers to an indirect and/or direct connection between the identified elements, components, and/or objects. Often the manner of the coupling will be related specifically to the manner in which the two coupled elements interact.

“Dovetail Joint” generally refers to a mechanical connection between two objects that utilizes a pin protruding from one object and a slot defined by the other object. The pin can be shaped in many forms. For example, the pins can be shaped like a stud, rail, or rib, to name just a few examples. In some cases, a dovetail joint includes multiple pins and slots. Typically, but not always, the pins have trapezoid shape such that the wider portion of the pin is positioned further into the slot. The slot generally extends through at least one side of the object such as to allow the pin of the other object to slide into the slot through the open side. In some cases, the pin and slot are shaped such that as to stop one object from sliding relative the other object at a certain point in one direction. In one example, a dovetail joint includes additional structures to secure the connection between the two objects. For example, to maintain the relative positions of the joined objects, a dovetail joint can further utilize adhesive between the objects, a stud on one object that pops into a divot on another object, and/or a wedge inserted into the joint to name a few examples.

“Edge” generally refers to a border where an object or area begins or ends. The edge is typically in the form of a line or line segment that is at the intersection of two plane faces or of two planes of an object or space.

“Electrically Connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Euroblock” or “Phoenix Connector” generally refers to a type of extra-low voltage disconnectable or pluggable terminal block. “Euroblock” is short for “European-style terminal block.” The Euroblock is sometimes referred to as a “Phoenix Connector” which refers to a manufacturer of a brand of Euroblocks, Phoenix Contact, though other companies manufacture Euroblocks. Phoenix Contact sells Euroblock type terminals under the brand COMBICON®. The Euroblock is a solderless connector that clamps to wires and is able to be plugged into a matching socket in an electronic device. Euroblocks are for example commonly used for microphone signals, line level-audio signals, and control signals.

“Frame” generally refers to a structure that forms part of an object and gives strength and/or shape to the object.

A “Friction Fit” or “Interference Fit” or “Pressed Fit” generally refers to type of coupling between two parts. Typically, the two parts fit tightly against each other. One or more segments of the parts are configured to interact. In some examples, one part defines a hole and/or opening configured to receive a portion of the other part. The tolerance between interacting segments of the parts is typically low, such as below 1 millimeter, 100 micrometers, 10 micrometers, and/or another width. Frictional force between the parts is configured to hold the parts together in a friction fit. In some cases, the parts are pressed together to create a friction fit. In another example, the parts can form a friction fit through expansion and/or contraction of one of the parts, such as due to temperature changes and/or other deformation. A friction fit can be reversible and allow the parts to be repeatedly coupled and decoupled, or the friction fit can permanently couple the two parts.

“Gap” generally refers to a space between objects, surfaces, or points.

“Helical Spring” or “Coil Spring” generally refers to a type of spring that is formed in the shape of a helix and that returns to an initial length of the spring when unloaded. Typically, but not always, the helical springs are made of elastic material like metal and/or plastic. For example, helical springs can include tension, compression, and torsion springs, to name just a few.

“Hole” generally refers to a hollow portion through a solid body, wall or a surface. A hole may be any shape. For example, a hole may be, but is not limited to, circular, triangular, or rectangular. A hole may also have varying depths and may extend entirely through the solid body or surface or may extend through only one side of the solid body.

“Insulator” or “Insulative Material” generally refers to a material and/or object whose internal electric charges do not flow freely such that very little electric current will flow through the material under the influence of an electric field under normal operating conditions. By way of non-limiting examples, insulator materials include materials having high resistivity, such as glass, paper, ceramics, rubber, and plastics.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Mortise and tenon joint” generally refers to a structure where at least two parts are interlocked together through a mortise hole or opening and the tenon tongue or member. Typically, but not always, the components attached together with the mortise and tenon joint are oriented transverse to one another, usually at a 90 degree angle. The mortise is a hole, slot or other opening in which the tenon is received. By way of nonlimiting examples, the mortise can include an open mortise, a stub mortise, a through mortise, a wedged half-dovetail mortise, and through-wedge half dovetail designs, to name just a few. The tenon is a projecting structure that is received in the mortise. By way of nonlimiting examples, the tenon can include stub tenon, through tenon, loose tenon, biscuit tenon, pegged/pinned tenon, tusk tenon, teasel tenon, top tenon, hammer-headed tenon, and half shoulder tenon type designs, to name just a few examples. Typically, but no always, the mortise and tenon have similar dimensions to promote a tight fit between the two attached components.

“Notch” generally refers to an indentation, cut, groove, channel, and/or incision on an edge or surface. In some non-limiting examples, the notch includes a V-shaped or U-shaped indentation carved, scratched, etched, stamped, and/or otherwise formed in the edge or surface. The notch can have a uniform shape or a non-uniform shape.

“Opening” generally refers to a space or hole that something can pass through.

“Pin” or “Peg” generally refers to an elongated piece of material such as wood, metal, plastic and/or other material. Typically (but not always), the pin is tapered at one or both ends, but the pin can be shaped differently in other examples. For example, the ends of the pin can be flattened, widened, and/or bent in order to retain the pin. Pins can be used for any number of purposes. For example, the pin can be used in machines to couple components together or otherwise act as an interface between components. Pins can also be used for holding things together, hanging things on, and/or marking a position. Normally, but not always, the pin is a small, usually cylindrical piece. In certain cases, the pin is pointed and/or a tapered piece used to pin down, fasten things together, and/or designed to fit into holes. In other examples, the pin can have a polyhedral shape, such as with a rectangular or triangular cross-sectional shape, or an irregular shape.

“Recessing” means here a space, recess or divot in an object which is set back or indented from other portions or surfaces of the object. Recessing may have various shapes or forms.

“Snap-Fit Connector” or “Snap-Fit Connection” generally refers to a type of attachment device including at least two parts, with at least one of which being flexible, that are interlocked with one another by pushing the parts together. The term “Snap-Fit Connector” may refer to just one of the parts, such as either the protruding or mating part, or both of the parts when joined together. Typically, but not always, the snap-fit connector includes a protrusion of one part, such as a hook, stud, and/or bead, that is deflected briefly during the joining operation and catches in a depression and/or undercut in the mating part. After the parts are joined, the flexible snap-fit parts return to a stress-free condition. The resulting joint may be separable or inseparable depending on the shape of the undercut. The force required to separate the components can vary depending on the design. By way of non-limiting examples, the flexible parts are made of a flexible material such as plastic, metal, and/or carbon fiber composite materials. The snap-fit connectors can include cantilever, torsional, and/or annular type snap-fit connectors. In the annular snap-fit type connector, the connector utilizes a hoop-strain type part to hold the other part in place. In one form, the hoop-strain part is made of an elastic material and has an expandable circumference. In one example, the elastic hoop-strain part is pushed onto a more rigid part so as to secure the two together. Cantilever snap-fit type connectors can form permanent type connections or can be temporary such that the parts can be connected and disconnected multiple times. A multiple use type snap-fit connector typically, but not always, has a lever or pin that is pushed in order to release the snap-fit connection. For a torsional snap fit connector, protruding edges of one part are pushed away from the target insertion area, and the other part then slides in between the protruding edges until a desired distance is reached. Once the desired distance is reached, the edges are then released such that the part is held in place.

“Socket” generally refers a device into which something fits in order to electrically and/or physically connect another electrical device to a circuit.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Terminal” generally refers to a plug, socket or other connection (male, female, mixed, hermaphroditic, or otherwise) for mechanically and electrically connecting two or more wires or other conductors.

“Terminal Block” or “Connection Terminal” generally refers to a modular device that includes an insulated frame or housing that electrically connects and secures two or more electrically conductive devices or parts together such as wires. In one form, the terminal block includes a clamping component, such as for clamping to wires, and a conducting strip that electrically connects wires or other parts together. The clamping component and conducting strip are typically housed in the insulative housing. There are various types of terminal blocks including, but not limited to, single level pass-through terminal blocks, dual level terminal blocks, three level terminal blocks, pluggable type terminal blocks (e.g., Euroblocks), ground terminal blocks, fused connection terminal blocks, thermocouple terminal blocks, and switch type terminal blocks.

“Wire” generally refers to elongated electrically conductive metal. This includes an individual strand, multiple strands (twisted, braided and/or not), traces, strips and other cross-sectional geometries. In some examples, wire is uninsulated wire, such as bare wire without a coating and/or plating. In other examples, wire is insulated wire with a coating of non-conductive material surrounding the wire. In some examples, insulated wire is coated with plastic, fluoropolymer, and/or rubber materials.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 system
105 terminal block assembly
110 wire
115 port
120 terminal block
125 body
130 plug
135 connector system
140 wire opening
145 lever
150 conductive portion
155 insulated portion
160 plug opening
165 pin
205 shell
210 cover
215 peg
217 dowel
220 fin
225 closed position
305 pin opening
310 snap-fit connection
315 hole
317 dowel hole
320 trough
325 recess
330 notch
405 ridge
410 groove
505 flange
510 clasp
515 slot
605 open position
705 cavity
707 receptacle
710 busbar
715 spring
720 strut
725 socket
730 transitional portion
735 base
740 fulcrum
745 arm
750 bend
755 leg
760 aperture
805 relaxed position
810 heel
815 bracket
820 base support
825 spring stopper
830 brace
835 lever stopper
840 divot
845 ledge
905 compressed position
910 edge
915 gap
920 tail
925 pocket
930 cam surface
1205 spring guide
1305 bridge
1310 bridge space
1315 leaf
1320 pin receptacle
1325 arch
1330 lip
1335 mouth
1340 bus guide
1505 plug frame
1510 slot
1515 internal hole
1517 stud hole
1520 lever pivot
1705 panel
1710 plug strut
1715 internal peg
1717 stud
1720 spring recess
1905 first terminal block
1910 second terminal block
1915 first shell
1920 first cover
1925 second shell
1930 second cover
2005 first plug
2010 second plug
2015 plug gap
2105 first block peg
2110 second block hole
2205 first block dowel
2210 second block hole
2305 divider
2310 rut
2315 device

What is claimed is:

1. A system, comprising:
a terminal block including
a busbar including a socket configured to receive a pin,
a spring having a loop shape,
wherein the spring is configured to couple a wire to the busbar,
a lever configured to pivot to actuate the spring,
wherein the lever is configured to pivot between a closed position and an open position, and
a connector system configured to couple the terminal block to a second terminal block; and
wherein the terminal block is a pluggable type terminal block.

2. The system of claim 1, further comprising:
the second terminal block being connected to the terminal block via the connector system;
wherein the connector system includes one or more pegs and one or more holes; and
the pegs are coupled to the holes.

3. The system of claim 2, wherein:
the terminal block includes a shell and a cover;
the holes extend fully through the shell; and
the pegs extend from both sides of the cover.

4. The system of claim 1, wherein:
the terminal block and the second terminal block each have a shell that defines one or more holes;
the holes extend fully through the shell;
the terminal block has a cover;
the cover has one or more pegs extending from opposite sides of the cover;
the pegs of the cover on one side of the cover are received in the shell of the terminal block; and
the pegs on an opposite side of the cover are received in the shell of the second terminal block.

5. The system of claim 1, wherein:
the terminal block includes a shell and a cover; and
the cover is snap-fitted to the shell.

6. The system of claim 5, wherein:
the cover has a flange;
the shell includes a clasp;
the shell defines a slot; and
the clasp is configured to secure the flange within the slot.

7. The system of claim 1, wherein:
the socket includes at least two leaves;
the socket includes a bridge that spans between the leaves;
the bridge is configured to space at least one of the leaves from the others; and
the busbar forms one of the leaves.

8. The system of claim 7, wherein:
the leaves curve to form arches;
the arches curve away from each other to form lips;
the arches are configured to compress a pin between each other; and
the lips are configured to guide the pin into the socket.

9. The system of claim 7, wherein:
the bridge is c-shaped; and
the bridge extends around a portion of the terminal block.

10. A system, comprising:
a terminal block including
a busbar including a socket configured to receive a pin,
wherein the socket includes at least two leaves,
wherein the socket includes a bridge that spans between the leaves,
wherein the socket is configured to secure the pin between the leaves,
a spring configured to couple a wire to the busbar,
a lever configured to pivot to actuate the spring,
wherein the lever is configured to pivot between a closed position and an open position,
wherein the terminal block is configured to receive a wire when the lever is in the open position,
wherein the terminal block is configured to couple to the wire when the lever is in the closed position, and
a plug configured to plug into a port.

11. The system of claim 10, wherein:
the leaves curve to form arches;
the arches curve away from each other to form lips;
the lips define a mouth that is configured to receive the pin; and
the lips are configured to guide the pin into the socket.

12. The system of claim 10, wherein:
the terminal block includes a ledge configured to support the socket; and
the bridge is configured to extend around the ledge.

13. The system of claim 10, wherein:
the spring defines an aperture;
the spring having a base resting against the busbar;
the spring has an arm with a leg that extends past the busbar and a fulcrum connecting the base to the arm;
the spring is configured to flex between a first position and a second position; and
the aperture is configured to retain the wire in the second position.

14. The system of claim 10, wherein:
the terminal block includes a bracket;
the bracket supports the spring; and
the spring wraps around a portion of the bracket.

15. The system of claim 10, wherein:
the terminal block is a first terminal block;
the first terminal block is configured to couple to a second terminal block;
the first terminal block includes a first plug and the second terminal block includes a second plug;
the first terminal block is configured to sit flush against the second terminal block; and
the first plug and the second plug define a gap between each other.

16. A system, comprising:
a terminal block including
a plug configured to plug into a port,
a busbar including a socket configured to receive a pin,
a spring configured to couple a wire to the busbar,
wherein the spring has a base resting against the busbar,
wherein the spring has an arm with a leg that extends past the busbar and a fulcrum connecting the base to the arm,
a lever having a cam surface configured to contact the spring as the lever rotates,
wherein the lever is configured to pivot between a closed position and an open position,
wherein the lever is bistable in the closed position and the open position,
wherein the spring is configured to flex between the closed position and the open position,
wherein the spring defines an aperture to receive the wire in the open position, and
wherein the aperture of the spring closes to retain the wire against the busbar when in the closed position.

17. The system of claim 16, wherein:
the spring includes an edge at the aperture;
wherein the edge and the busbar define a gap; and
wherein the edge is configured to press the wire against the busbar to electrically connect the wire and the busbar.

18. The system of claim 16, wherein:
the terminal block includes a bracket;
the spring wraps around a portion of the bracket;
the bracket is at least in part round; and
the fulcrum of the spring is positioned around the bracket.

19. The system of claim 16, wherein:
the terminal block defines a cavity;
the cavity is configured to receive the spring and busbar;
the cavity is shaped to receive the spring and busbar in a single motion;
the terminal block includes a shell and a cover;
the shell defines the cavity; and
the cover covers the cavity.

20. The system of claim 16, wherein:
the terminal block includes a connector system; and
the connector system is configured to couple the terminal block to a second terminal block.
